(19) United States
(12) Patent Application Publication
(10) Pub. No.: US 2016/0217435 A1
(43) Pub. Date: Jul. 28, 2016

(54) DATA SECURITY SYSTEM FOR ELECTRONIC PAYMENTS

(71) Applicant: TrustFunds, LLC, Blaine, MN (US)

(72) Inventors: Lynn Leegard, Blaine, MN (US); Karen Hauer, Eagan, MN (US); Terry Hauer, Eagan, MN (US); Dawn Lunde, Lakeville, MN (US); Greg Selner, Apple Valley, MN (US); Dan Selner, West Saint Paul, MN (US)

(21) Appl. No.: 15/004,550

(22) Filed: Jan. 22, 2016

Related U.S. Application Data
(60) Provisional application No. 62/106,626, filed on Jan. 22, 2015.

(51) Int. Cl. G06Q 20/02; G06Q 20/38

(52) U.S. Cl. CPC G06Q 20/023; G06Q 20/3829; G06Q 2220/00

(57) ABSTRACT

A data security system that electronically processes payment transactions is provided herein to assist in securely moving data and payments from a bank account directly into a designated trust account while bypassing unsecure, intermediate steps and processes. Although it is standard practice for a buyer's payment to be handled by the buyer, the buyer's agent, the listing agent, and the broker or designated trust account holder before the check is deposited to a trust account at a bank, due to the high number of entities that handle the payment, the optimal transaction security may not be obtained by the standard practice. Finding a solution for the optimal transaction security may require minimizing the number of entities that handle payments and minimizing distribution of confidential information, particularly if the confidential information involves specific bank account details. The benefit is more direct and more secure movement of payment information amongst transacting entities.

### CROSS-REFERENCE TO RELATED APPLICATION

This application claims the benefit of U.S. Provisional Patent Application Ser. No. 62/106,626, filed on Jan. 22, 2015, titled SECURE TRANSACTION SYSTEM.

### FIELD OF THE DISCLOSURE

This disclosure generally relates to a data security system that electronically processes payment transactions. More specifically, the present disclosure relates to a system that securely moves data and payments from a first bank account directly into a designated trust account while bypassing unsecure, intermediate steps and processes.

### BACKGROUND OF THE INVENTION

Real estate agents represent both buyers and sellers in transactions. Historically most, if not all, of the communication and paperwork for real estate transactions has been done in person. In the past few years, the real estate industry has shifted to allow and provide electronic processes for how documents and contracts are completed, signed, delivered, stored and managed. Although the legal and financing processes and documentation have transitioned to online and digital solutions, the handling of earnest money associated with these electronic transactions continues to be reliant on the physical delivery of paper checks due to many challenges.

Real estate is a highly regulated industry. All 50 states have licensing statutes that govern activities which activities are required, permitted, and prohibited. One area that is of particular concern to regulators is the manner in which licensees, whether a real estate broker, title company or escrow company, handle money received in a fiduciary capacity. This includes earnest money as part of a real estate transaction. The regulators are concerned about how such money is handled, delivered, deposited into, and refunded out of any licensee's trust account.

Although it may vary slightly from state to state, there is a required timeframe for when earnest money must be delivered and ultimately deposited into a trust account. This timeframe may be mandated by state statute or by agreement between the buyer and seller in a purchase agreement. The required timeframe dictated by state statute is typically very short (as little as two business days in some states such as Ohio, North Dakota and Texas; and three business days in many other states such as Minnesota, just to name a few). Unfortunately, the antiquated method of writing paper checks and physically delivering them is often not done within the constraints of the time requirements.

In addition, the holder of a trust account is required to track when earnest money is received in order to demonstrate that a deposit was made within the required timeframe. This is especially cumbersome and difficult when the real estate broker is holding the earnest money in its trust account because “receipt” may occur when the real estate agent within the company receives the funds, not when the broker or its office receives the funds. That requires the broker to manually track the date of receipt and to rely on information provided by its agents. Trust account holders are also required to keep accurate information about the activity in their trust account by documenting when funds are deposited, accounting for all of the funds and matching them to a particular transaction.

As part of a loan application and approval for a mortgage, a borrower is required to demonstrate to a lender that the funds used for the purchase are, in fact, that of the borrower. Currently, it is typical for a buyer to write a paper check for the earnest money. The lender, however, before giving the buyer credit at closing for the amount of the earnest money, requires that the buyer demonstrate that the money actually came from the buyer's personal bank account. This obligation is a cumbersome process requiring the buyer to provide the lender with a full bank statement along with a physical copy of both the front and the back of the earnest money check. The physical copy of the check is required, since in many instances a bank statement does not provide sufficient detail on who received the payment.

Earnest money payments in a real estate transaction are unique from other payment transactions. The buyer does not typically have direct connection or communication with the company to which it is making the earnest money payment; and yet the funds must go directly from the buyer's bank account to the designated trust account without depositing first into a third party account.

Lastly, as the rest of the industry continues to be more digitally based, an increasing number of consumers simply do not have a checking account; or may have such an account, but may not order or own physical paper checks. In order for these buyers to make their earnest money payment, they often must go to the trouble and expense of obtaining a cashier's check. This will result in the buyer's bank account appearing as if it had a large cash withdrawal with no documentation as to where the funds went, again causing an obstacle in the financing process. Another option in these cases is for the buyer to pay their earnest money by wire transfer, which can add on additional fees to an already large expense and which requires the designated trust account holder to disclose to the buyer the bank account information for its trust account.

Therefore, in order to comply with contract terms, state regulations and lender requirements for both the timely deposit into a designated trust account and the strict documentation of earnest money payments, a physical paper check often must be driven from the buyer to the buyer's agent, and finally delivered to the designated trust account holder which may be the buyer's broker, the listing broker, a title company, an escrow company or a law firm where the check is finally processed and delivered to the bank for deposit. While it may be possible that the physical delivery of paper checks may comply with applicable rules, regulations, and lender requirements, this process poses other serious issues.

In today's real estate market, many real estate agents and brokers work in very widespread geographic areas. Therefore, the physical delivery of earnest money checks is a much bigger burden in transactions than it historically was when agents and brokers tended to focus on a small geographic market. The USPS, messenger services, or overnight delivery services can be costly and unreliable alternatives and may create difficulty in documenting the date on which the designated trust account holder received the check. In addition, using these delivery methods does not provide for the ability to control who actually receives and views the check and, therefore, unauthorized individuals may have access to the buyer's personal financial information.

Regulators are concerned about how a consumer's personal financial information is secured. A buyer's personal and financial information, including their full bank account number, appears on their paper check and passes through many hands before it is finally deposited into the designated trust account. The parties that may have access to the buyer's information may be the real estate agents, brokers, including office and accounting staff, title companies, and escrow companies and their staff and lenders, including loan officers and their staff. This creates a great risk of potential identify theft, as well as potential liability for every person and company responsible for the secure handling of the paper check.

Another issue is the lack of information regarding the status of the earnest money payment. Once a buyer hands over the earnest money check to the buyer's agent, the buyer has no way of tracking who has the check and when it is deposited into the designated trust account. In addition, other parties involved in the transaction cannot track the status of the earnest money payment. For example, the designated trust account holder, whether it is a buyer's broker, listing broker, title company, escrow company, or law firm, does not know when to expect delivery of the earnest money check. Plus, if the paper earnest money check is returned by the buyer's bank for any reason, including non-sufficient funds, that bank notification process can take up to ten business days. This lengthy period of time creates a risk for sellers in a transaction since they believe that the designated trust account holder is holding the buyer's earnest money when in fact, it is not. Notifying the buyer and all other interested parties in the transaction of the return and obtaining a new check starts the long process all over again, which could severely jeopardize the real estate transaction.

Finally, another issue caused by the physical handling of paper earnest money checks is the frustration over the very manual and slow process of refunding the buyer's earnest money in the event a purchase agreement is canceled. First, the designated trust account holder must verify that the earnest money has in fact settled in the trust account. Failure to do so may result in returning money to a buyer from a trust account that has not yet been received, and may not be received if the check is returned, causing a regulatory issue with the trust account. For this reason, the designated trust account holder may require ten to even as many as 30 days before producing and mailing a physical check back to the buyer. This too may create a regulatory issue, since many licensing statutes have specific timeframes regulating when earnest money must be released from a trust account following a cancellation of a purchase agreement. In addition, a delay in returning the earnest money may cause significant issues for the buyer. For instance, the buyer may need those funds to pay earnest money required by a purchase agreement for a different real estate transaction.

Therefore, a system is needed that is secure, web-based, available to all parties in a real estate transaction, and capable of handling every step of the earnest money payment process including, if necessary, a return of the buyer's earnest money in the event of a cancellation.

### SUMMARY OF THE INVENTION

The disclosed transaction system is a secure, web-based solution that provides for the electronic processing of payments from a buyer's bank account directly into a designated trust account. According to some embodiments of the present disclosure, the disclosed transaction system can be applied to real estate transactions and the payment can be an earnest money payment. The disclosed secure transaction system provides real-time notification of transaction status to all parties involved in the transaction. Each step in the process of the money payment, from the buyer submitting the payment, to the funds settling in the designated trust account, are date and time stamped for clear and complete reporting and auditing purposes by all applicable parties. Additionally, because the transaction is processed electronically directly from the buyer's bank account to the designated trust account, both bank accounts record the transaction with much greater detail than what would be recorded with a paper check.

Further, refunding a buyer's money payment can be processed electronically in the disclosed secure transaction system upon real-time notification that the money payment has settled, which results in a much faster refund to the buyer. In addition, the refund can be processed without re-entering the buyer's bank account information or providing the buyer with a paper check from the designated trust account. A paper check from the trust account would result in the buyer having access to the bank account information of the trust account. An electronic refund provides that the trust account information remains secure without sharing it with a consumer. The buyer and all parties are notified when a refund is processed electronically through the disclosed transaction system with a full transaction detail including date and time stamp and the status of the transaction.

### BRIEF DESCRIPTION OF THE DRAWINGS

FIG. 1 illustrates one example of the process described in the present disclosure.

FIG. 2 illustrates an algorithm used by the disclosed system to determine the Trust Account according to one embodiment of the present invention.

FIG. 3 is an example graphical user interface according to one embodiment of the present invention.

FIG. 4 is an example graphical user interface according to one embodiment of the present invention.

FIG. 5 is an example graphical user interface according to one embodiment of the present invention.

FIG. 6 is an example graphical user interface according to one embodiment of the present invention.

FIG. 7 is an example graphical user interface according to one embodiment of the present invention.

FIG. 8 is an example graphical user interface according to one embodiment of the present invention.

FIG. 9 is an example graphical user interface according to one embodiment of the present invention.

FIG. 10 is an example graphical user interface according to one embodiment of the present invention.

FIG. 11 is an example graphical user interface according to one embodiment of the present invention.

FIG. 12 is an example graphical user interface according to one embodiment of the present invention.

FIG. 13 is an example graphical user interface according to one embodiment of the present invention.

FIG. 14 is an example graphical user interface according to one embodiment of the present invention.

FIG. 15 is an example graphical user interface according to one embodiment of the present invention.

FIG. 16 is an example graphical user interface according to one embodiment of the present invention.

FIG. 17 is an example graphical user interface according to one embodiment of the present invention.

FIG. 18 is an example graphical user interface according to one embodiment of the present invention.

FIG. 19 is an example graphical user interface according to one embodiment of the present invention.

FIG. 20 is an example graphical user interface according to one embodiment of the present invention.

FIG. 21 is an example graphical user interface according to one embodiment of the present invention.

FIG. 22 is an example graphical user interface according to one embodiment of the present invention.

FIG. 23 is an example graphical user interface according to one embodiment of the present invention.

FIG. 24 is an example graphical user interface according to one embodiment of the present invention.

FIG. 25 is an example graphical user interface according to one embodiment of the present invention.

FIG. 26 is an example graphical user interface according to one embodiment of the present invention.

FIG. 27 is an example graphical user interface according to one embodiment of the present invention.

FIG. 28 is an example graphical user interface according to one embodiment of the present invention.

FIG. 29 is an example graphical user interface according to one embodiment of the present invention.

FIG. 30 is an example graphical user interface according to one embodiment of the present invention.

FIG. 31 is an example graphical user interface according to one embodiment of the present invention.

FIG. 32 is an example graphical user interface according to one embodiment of the present invention.

FIG. 33 is an example graphical user interface according to one embodiment of the present invention.

FIG. 34 is an example graphical user interface according to one embodiment of the present invention.

FIG. 35 is an example graphical user interface according to one embodiment of the present invention.

FIG. 36 is an example graphical user interface according to one embodiment of the present invention.

FIG. 37 is an example graphical user interface according to one embodiment of the present invention.

FIG. 38 is an example graphical user interface according to one embodiment of the present invention.

FIG. 39 is an example graphical user interface according to one embodiment of the present invention.

FIG. 40 is an example graphical user interface according to one embodiment of the present invention.

FIG. 41 is an example graphical user interface according to one embodiment of the present invention.

FIG. 42 is an example graphical user interface according to one embodiment of the present invention.

FIG. 43 is an example graphical user interface according to one embodiment of the present invention.

FIG. 44 is an example graphical user interface according to one embodiment of the present invention.

FIG. 45 is an example graphical user interface according to one embodiment of the present invention.

FIG. 46 illustrates a comparison of the traditional earnest money process and the disclosed invention.

FIG. 47 is an example graphical user interface according to one embodiment of the present invention.

FIG. 48 is an example graphical user interface according to one embodiment of the present invention.

FIG. 49 is an example graphical user interface according to one embodiment of the present invention.

FIG. 50 is an example graphical user interface according to one embodiment of the present invention.

FIG. 51 is an example graphical user interface according to one embodiment of the present invention.

FIG. 52 is an example graphical user interface according to one embodiment of the present invention.

FIG. 53 is an example graphical user interface according to one embodiment of the present invention.

FIG. 54 is an example graphical user interface according to one embodiment of the present invention.

FIG. 55 is an example graphical user interface according to one embodiment of the present invention.

FIG. 56 is an example graphical user interface according to one embodiment of the present invention.

FIG. 57 is an example graphical user interface according to one embodiment of the present invention.

FIG. 58 is an example graphical user interface according to one embodiment of the present invention.

FIG. 59 is an example graphical user interface according to one embodiment of the present invention.

FIG. 60 is an example graphical user interface according to one embodiment of the present invention.

FIG. 61 is a schematic block diagram depicting an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

The disclosed secure transaction system is directed to a secure, web-based solution that provides for the electronic processing of payment transactions, such as an earnest money transaction, to securely move data and payments from a buyer's bank account directly into a designated trust account while bypassing unsecure, intermediate steps and processes. Although it is standard practice for a buyer's payment to be handled by the buyer, the buyer's agent, the listing agent, and the broker or designated trust account holder before the check is deposited to a trust account at a bank, due to the high number of entities that handle the payment, the optimal transaction security may not be obtained by the standard practice. Finding a solution for the optimal transaction security may require minimizing the number of entities that handle payments and minimizing distribution of confidential information, particularly if the confidential information involves specific bank account details. Accordingly, the benefit is more direct and more secure movement of payment information amongst transacting entities.

The system can be used, for example, as part of a real estate transaction. In some embodiments, the system can be used by real estate brokers, title companies, escrow companies, law firms and any other firms that accept and hold earnest money in a fiduciary capacity and/or perform closing services for real estate transactions. These closing companies benefit because the system allows buyers a convenient and secure method to deposit their down payment and closing costs prior to closing without the inconvenience and high cost associated with a wire transfer. The functions of the disclosed system are more fully described below.

In addition to meeting the requirements of contract terms of all the industry rules, regulations, and lending requirements for both the timely deposit and documentation of earnest money payments, the disclosed secure transaction system provides real-time notification of transaction status to all parties involved in the transaction including buyers' agents, buyers' brokers, listing agents, listing brokers and any other designated trust account holder that receives the earnest money payments such as title companies, escrow companies, or law firms. Each step in the process of the earnest money payment, from the buyer receiving the earnest money request, to the buyer opening the payment form and submitting the earnest money payment, to the funds settling into the designated trust account, are date and time stamped for clear and complete reporting and auditing purposes by all applicable parties. Further, because the transaction is processed electronically directly from the buyer's bank account to the designated trust account, both bank accounts record the transaction with much greater detail than what would have been recorded with a paper check. This eliminates the need for the buyer to provide a lender with the front and back of an earnest money check, yet still satisfies the lender requirement of documenting the source of funds.

Further, refunding a buyer's earnest money payment can be processed electronically in the disclosed secure transaction system upon real-time notification that the earnest money payment has settled, which results in a much faster refund to the buyer. In addition, the refund can be processed without re-entering the buyer's bank account information or providing the buyer with a paper check from the designated trust account. A paper check from the trust account would result in the buyer having access to the bank account information of the trust account. An electronic refund provides that the trust account information remains secure without sharing it with a consumer. The buyer and all parties are notified when a refund is processed electronically through the disclosed transaction system with a full transaction detail including date and time stamp and the status of the transaction.

While processing financial transactions from one bank account to another bank account through the Automated Clearing House (ACH) System is an activity that already exists, there are several distinctions in how the disclosed secure transaction system functions that are unique.

For example, the disclosed secure transaction system brings together, in an online community, all parties involved in both sides of the earnest money payment transaction, thereby providing access to critical information about the status of the earnest money payment. Knowledge of this information is not available through any other current system. There is no other single system available today where buyers of real estate can (1) securely and timely submit their earnest money payment electronically directly into a designated trust account and (2) provide accurate, timely, and detailed status information about the earnest money payment to parties on the buyer's side of the transaction, the listing side of the transaction, and to all other parties involved in the transaction.

A fully executed purchase agreement for a real estate transaction provides the terms and conditions agreed to between a buyer and seller regarding the buyer's earnest money payment. Such terms include the amount of the earnest money and the named entity charged with receiving and holding the earnest money. That entity is herein referred to as the designated trust account holder. The designated trust account holder may be dictated by state statute or may be determined through negotiation between the buyer and seller. In some real estate markets, it is standard practice to deposit earnest money payments into the listing broker's trust account. In other markets, it is standard practice to deposit earnest money payments into the buyer broker's trust account. And in other real estate markets, the buyer and seller may negotiate as part of the purchase agreement to deposit earnest money payments to a trust account with a specified title company, escrow company, or law firm, any of which may also be involved in closing the real estate transaction.

The disclosed secure transaction system can partner with an ACH Processor, which is an entity responsible for creating and submitting transactions to the ACH banking system. The ACH Processor provides the disclosed transaction system with a Trust Account Key, described in more detail below, for each trust account it underwrites. When transaction information including the Trust Account Key is submitted to the ACH Processor, the buyer's bank account is debited and the correct trust account is credited. The ACH Processor can send real-time status information to the disclosed secure transaction system at each stage of the transaction.

Designated trust account holders that receive earnest money payments may maintain more than one trust account for the purposes of holding earnest money payments. Additional accounts may be required by state regulations or may be created by choice for a lawful business practice. For example, the account holder may create additional accounts to segregate funds for different types of transactions. There may be separate trust accounts for each office or group of offices within a designated trust account holder company. There may be a separate trust account designated to hold earnest money payments for each state in which properties are located. The disclosed transaction system has created an algorithm to ensure each earnest money payment is deposited into the correct trust account.

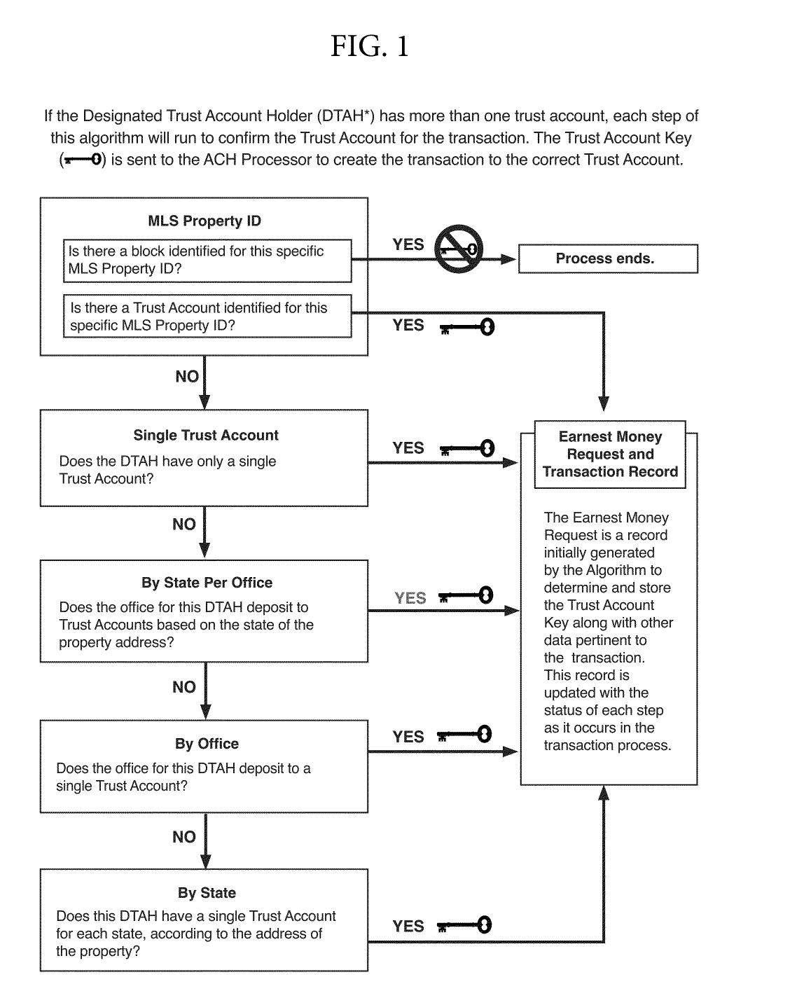

When a buyer's agent initiates the process to send an Earnest Money Request to the buyer, the disclosed transaction system will run each step of the algorithm, as illustrated in FIG. 1, in order to determine the correct trust account to use for the transaction. More specifically, the system will ask if there is a block identified for the specific property identified in the earnest money request. If there is, the process will end. If not, the system will ask if there is a trust account identified for the specific property. If there is an identified trust account, the Trust Account Key will be sent and stored in the “Earnest Money Request and Transaction Record.” If there is no identified trust account for the property, the system will next ask if the designated trust account holder has a single trust account. If the answer is yes, the Trust Account Key will be sent and stored in the “Earnest Money Request and Transaction Record.” If the answer is no, the system will then ask if the office for the designated trust account holder deposits to trust accounts based on the state of the property address. If the answer is yes, the Trust Account Key will be sent and stored in the “Earnest Money Request and Transaction Record.” If the answer is no, the system will then ask if the office for the designated trust account holder deposits to a single trust account. If the answer is yes, the Trust Account Key will be sent and stored in the “Earnest Money Request and Transaction Record.” If the answer is no, the system will then ask if the designated trust account holder has a single trust account for each state, according to the address of the property. If the answer is yes, the Trust Account Key will be sent and stored in the “Earnest Money Request and Transaction Record.”

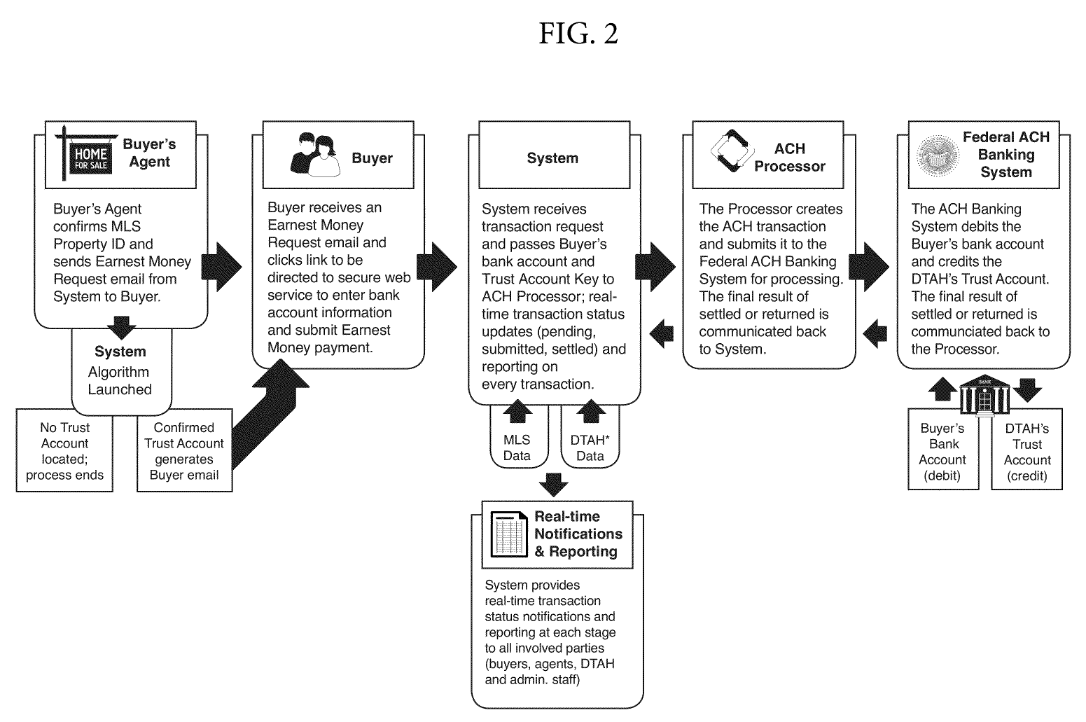

Therefore, in summary, if the property is flagged to block an electronic earnest money payment or if no trust account is located, the agent will not be able to send the earnest money request to the buyer, and the buyer will be required to submit the earnest money payment by some other means. However, if a trust account is found, the disclosed secure transaction system continues its process, as illustrated in FIG. 2. More specifically, the system confirms that it has determined the correct trust account for the property and will generate an email for the buyer that contains an Earnest Money Request hyperlink. Next, the buyer can click the Earnest Money Request hyperlink to be directed to a secure web service where the buyer can enter bank account information and submit the earnest money payment. After the buyer submits the payment, the system passes the buyer's bank account and the Trust Account Key to the ACH Processor, ensuring the funds are securely deposited into the correct trust account. The ACH Processor can create the ACH transaction and submit it to the Federal ACH Banking System for processing. The ACH Banking System will debit the buyer's bank account and credit the designated trust account holder's trust account and then communicate back to the ACH Processor whether the final result of the transaction is settled or returned. This final result (settled or returned payment) is communicated back to the disclosed system by the ACH Processor. In addition to this process, the system can provide real-time transaction status notifications and report updated statuses at each stage to each party that is involved in the transaction (ex: buyers, agents, designated trust account holders, administrative staff, etc.).

The disclosed secure transaction system is a unique software-as-a-service (“SaaS”) that connects consumers (i.e. buyers), real estate agents, and designated trust account holders in a secure environment for collecting, processing, tracking, managing, and reporting earnest money payments. In addition to the unique processes used by the disclosed secure transaction system, the system can collaborate with other services to supply accurate reporting and data and the ACH processing services.

First, the disclosed secure transaction system can collaborate with a multiple listing service (“MLS”) to provide limited, but accurate, and current property listing data that becomes part of each earnest money transaction. The MLS can provide broker and agent member data, broker and agent transaction history data, permission to receive and use MLS data, as well as promotional activities to encourage broker and agent participation. The MLS can pay a per member/per month subscription fee to the disclosed secure transaction system. Therefore, buyers' agents are able to use the disclosed secure transaction system at no additional charge and may facilitate an Earnest Money Request for the buyer as long as the designated trust account holder is a Member of the disclosed secure transaction system. A buyer's agent can assist the buyer in electronically submitting an earnest money payment, can receive all notifications, and can have the ability to view all reports even if the agent's own broker has not yet subscribed to the disclosed secure transaction system to receive earnest money payments.

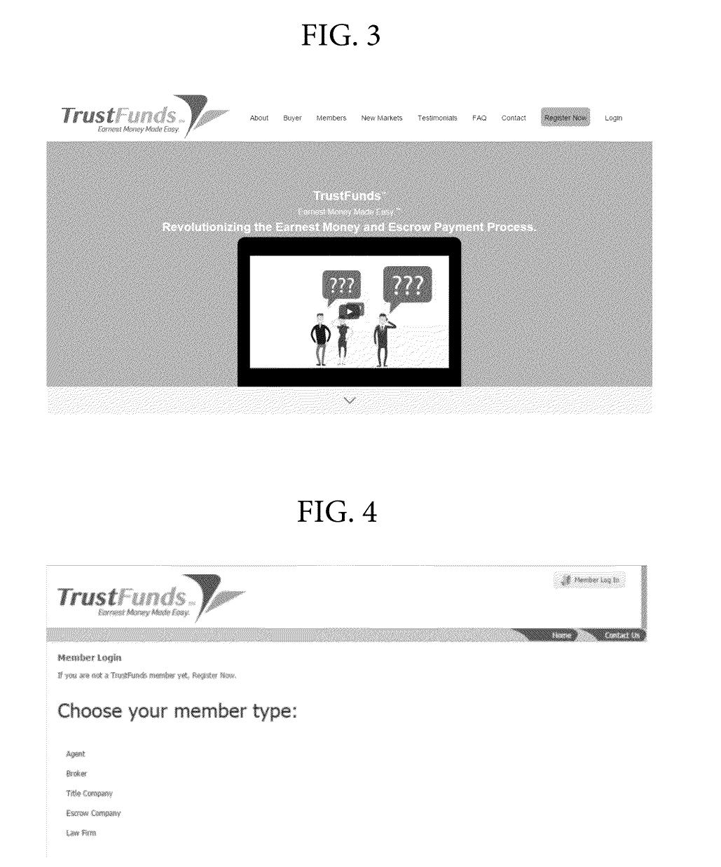

All designated trust account holders must register with the disclosed system. For example, a designated trust account holder can register by clicking on a registration button on a website hosted by the system, as illustrated in FIG. 3. The first step for the designated trust account holder is to select the appropriate Member Type, as illustrated in FIG. 4. The various Member Types include, but are not limited to, agent, broker, title company, escrow company, and law firm.

Brokers as a Designated Trust Account Holder

The disclosed secure transaction system is easy to use and saves all parties the liability and time-consuming hassle of delivering paper earnest money checks from buyers to the designated trust account holder. Plus, it greatly streamlines the earnest money process and provides constant tracking and reporting capabilities.

Real estate brokers can register with the disclosed secure transaction system and pay a monthly subscription fee, which operates on a sliding scale that is based on the broker's number of sold listings from the previous year. In some embodiments, brokers may register to have access to transaction data only and may not receive electronic earnest money payments to a trust account. In other embodiments, brokers may register to have access to transaction data and to have additional authority, such as the ability to receive electronic earnest money payments. In order for a broker to receive earnest money payments through the system, the broker must use the disclosed ACH Processor to activate an ACH processing account for each of the trust accounts for which the broker wishes to receive earnest money payments.

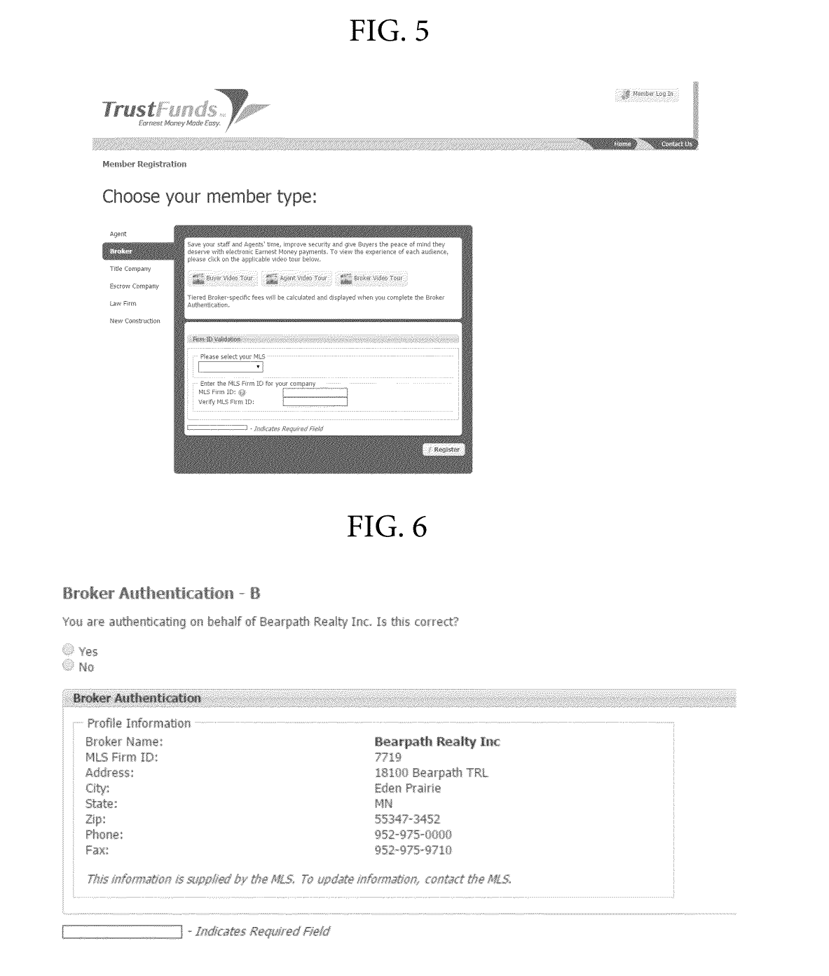

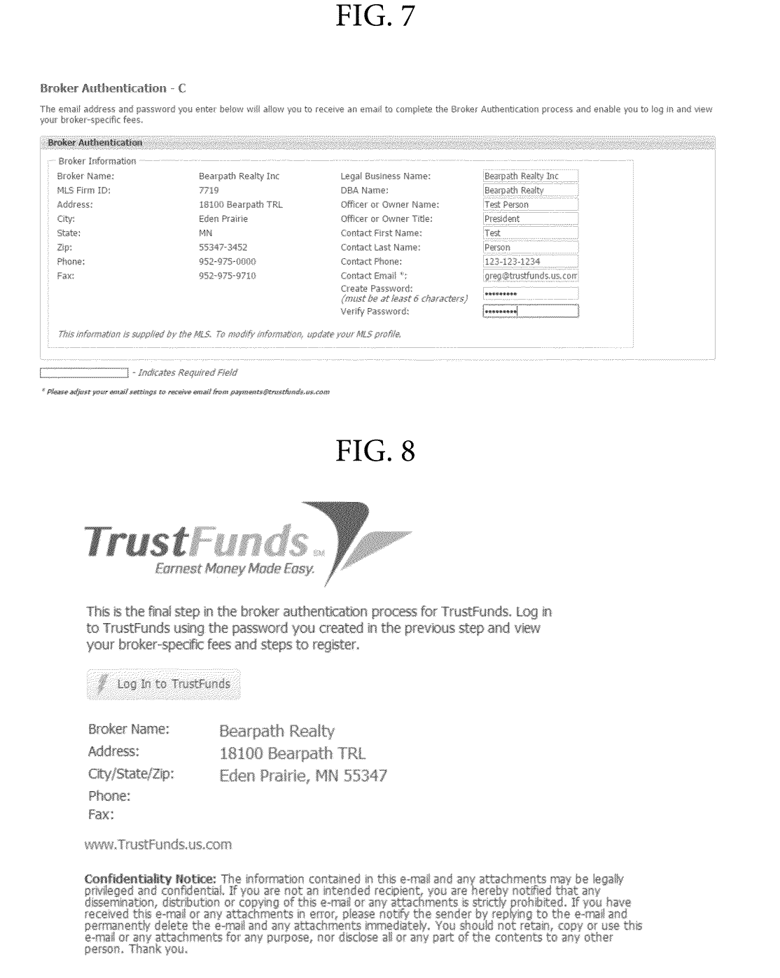

A broker registers to use the system by completing an authentication and 4-step registration process that utilizes data from the broker's MLS by first selecting the Member Type, such as broker, as illustrated in FIG. 4. Then the broker can select the MLS it wishes to register for and can enter its MLS identification number, as illustrated in FIG. 5. In order to initiate the registration process, the broker can authenticate the broker's organization, as illustrated in FIG. 6. Broker information from the MLS can then display, and the broker or staff member that is completing the registration process can populate information to create the broker account, as illustrated in FIG. 7. The information can include, but is not limited to, the legal business name, the DBA name, the officer's or owner's name, the officer's or owner's title, the contact's first name, the contact's last night, the contact's phone number, the contact's email, and a newly created password.

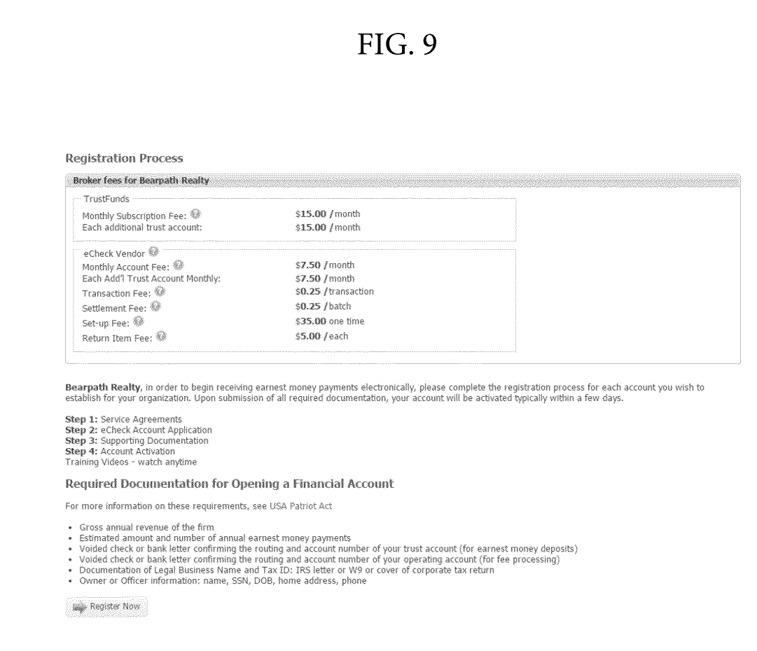

In some embodiments, after the broker provides the above-described information, the broker will receive a confirmation email at the email address the broker provided. The email can provide a link that will enable the broker to log in and finalize the authentication process, as illustrated in FIG. 8. Once authenticated, the broker can be presented with all applicable fees (which are determined from the broker record in the disclosed transaction system's database) and a summary of the registration steps along with a checklist of the required documentation required for opening a financial account, as illustrated in FIG. 9.

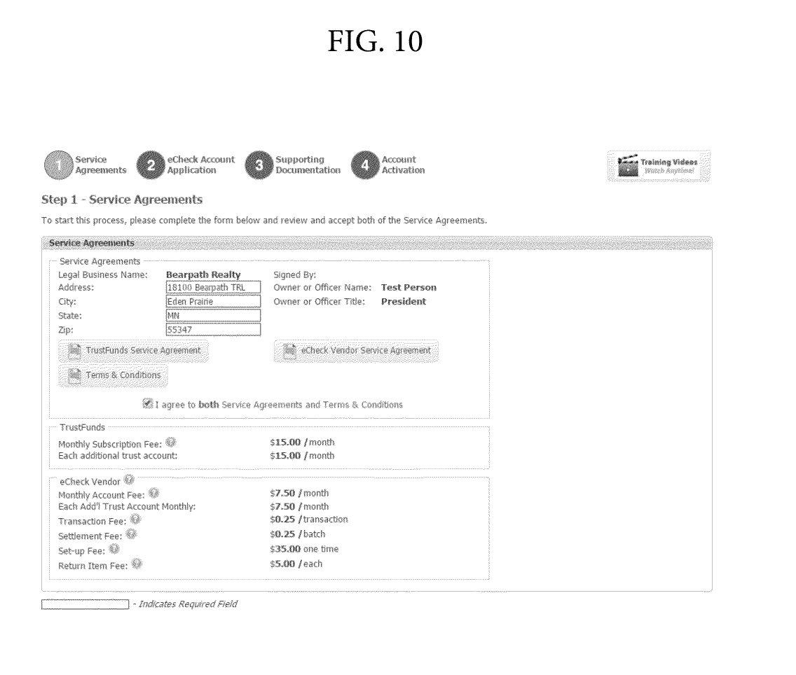

In some embodiments, Step 1, illustrated in FIG. 10, permits the broker to review and accept the terms of the service agreements of the disclosed transaction system and the ACH vendor (a/k/a the eCheck vendor) as well as the Terms and Conditions.

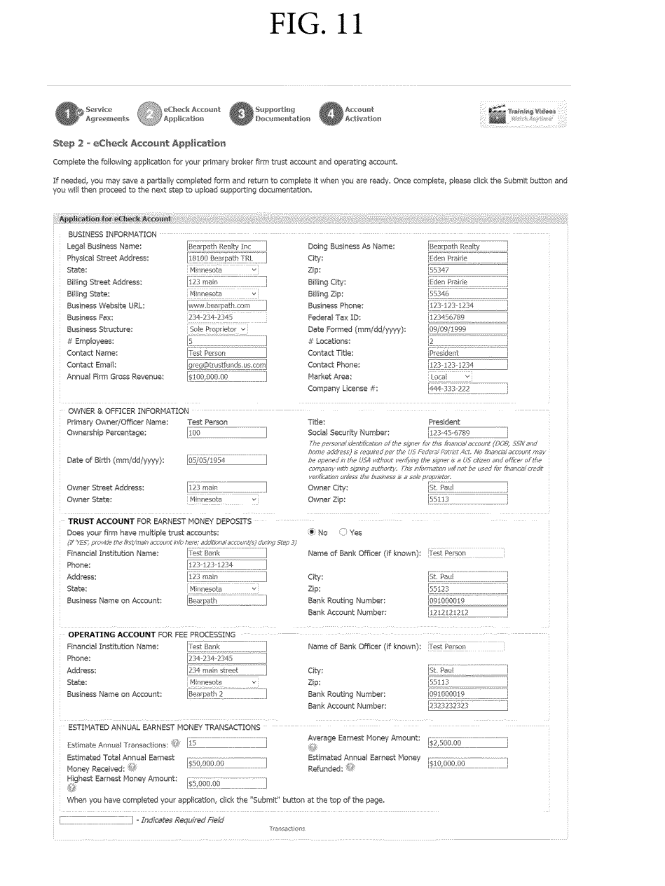

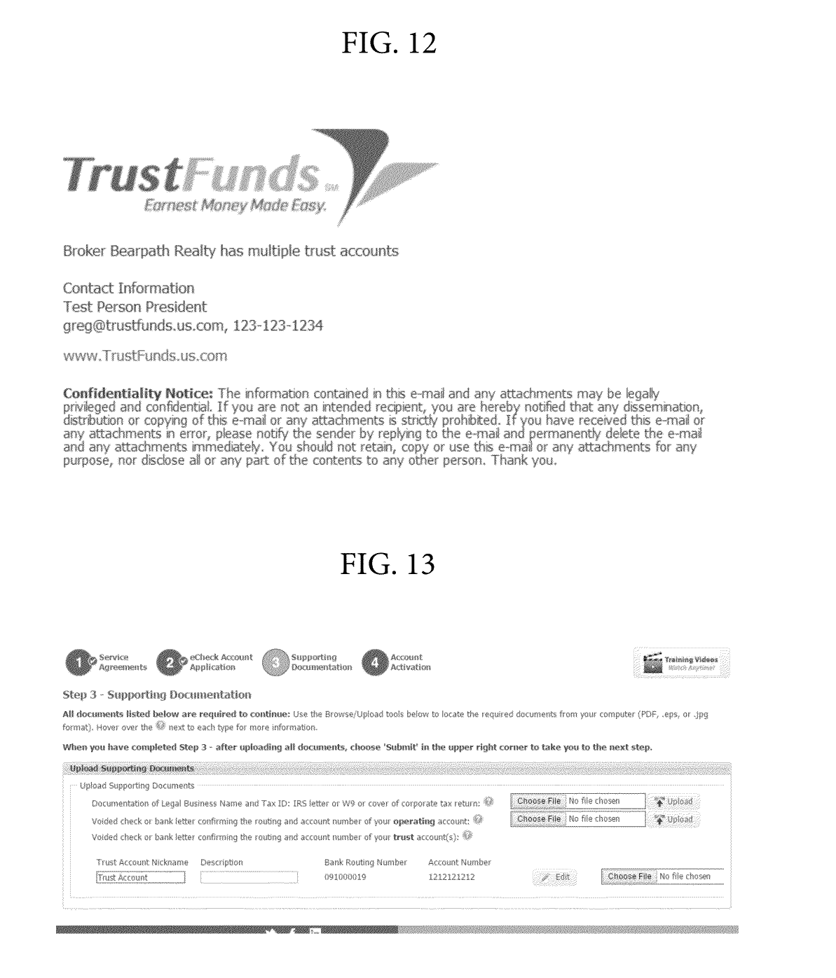

In some embodiments, Step 2, illustrated in FIG. 11, enables the broker to provide the information required to activate an ACH account, which enables the broker to receive electronic earnest money payments into a designated trust account(s). As part of the application, the broker can indicate whether its organization has one or more trust accounts. If the broker has more than one trust account, the broker can open an ACH account for each trust account. Earnest money payments to the proper trust account are based upon the system's algorithm, as described earlier. If the broker responds with a “Yes” to multiple trust accounts, a notification is sent to the disclosed secure transaction system's support staff, as illustrated in FIG. 12, to provide the broker with a Multiple Trust Account form to define how the trust accounts are managed within the broker's organization.

In some embodiments, Step 3, illustrated in FIG. 13, enables the broker to upload the required supporting documentation for the trust account(s) and the broker's operating account so the ACH account(s) can be underwritten. The disclosed secure transaction system allows the broker to upload documents of each type for all accounts.

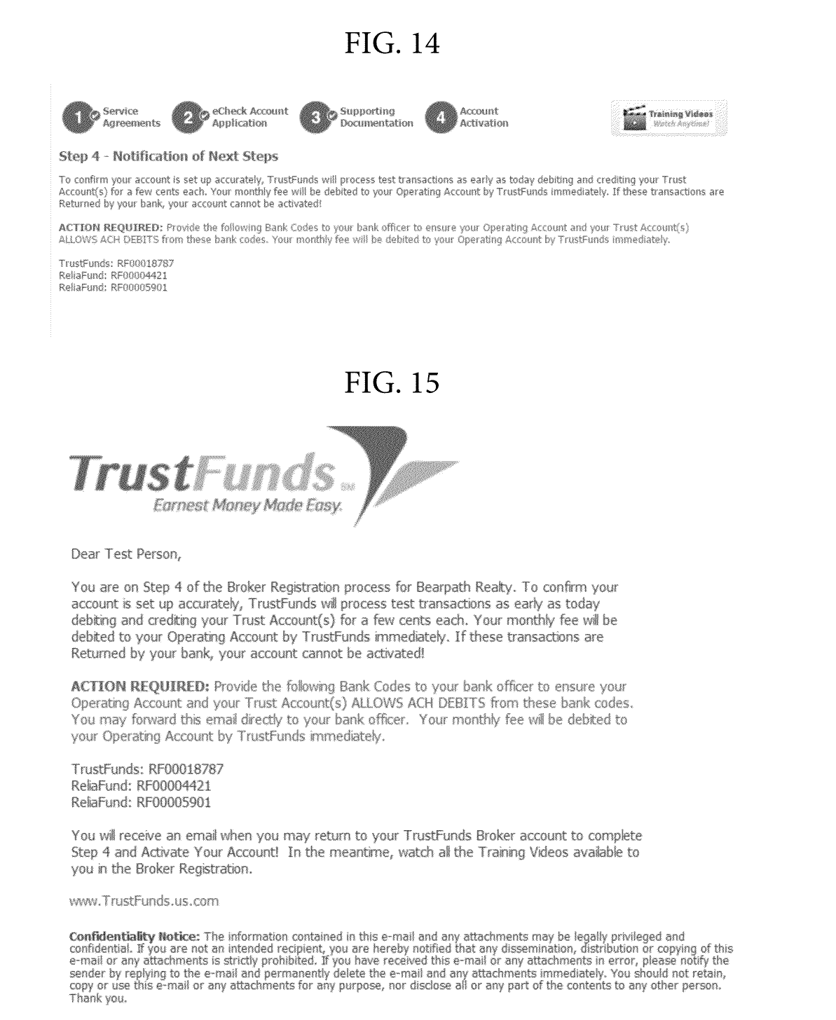

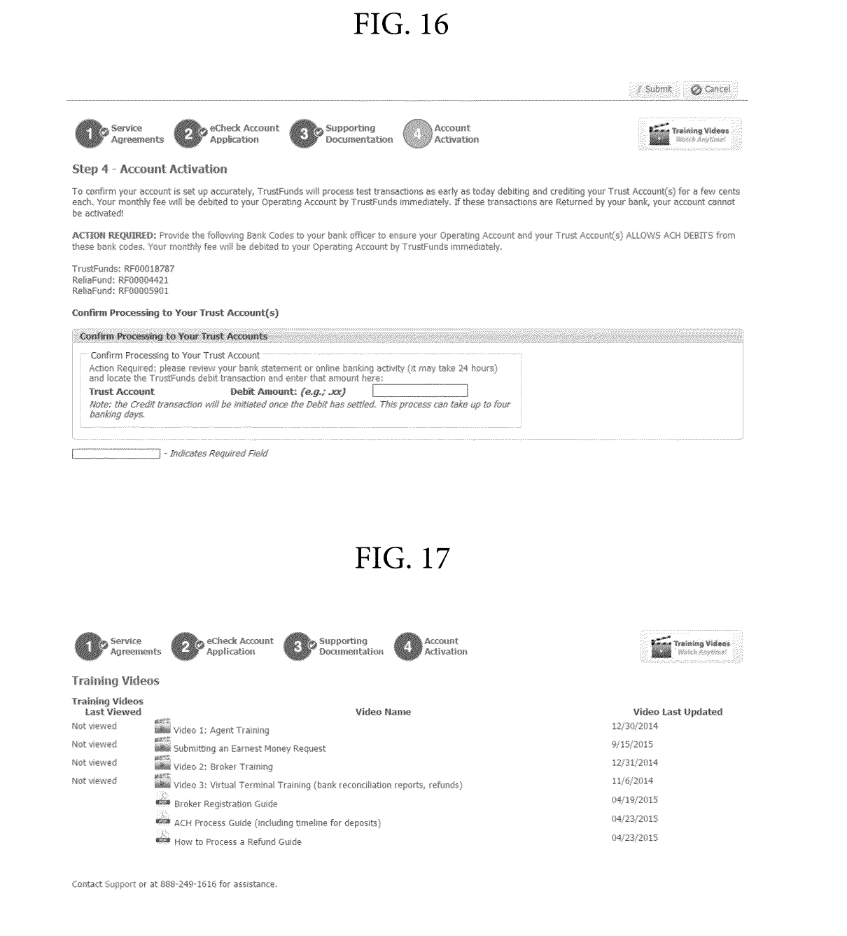

In some embodiments, the final step is Step 4, which can be a two-part process. First, as illustrated in FIG. 14, the broker can be advised that the account activation is in process and that the broker must wait until the ACH account is activated. Once activated, the system can proceed to the second part of Step 4, wherein the system auto-generates a debit transaction of a random dollar amount to each trust account to ensure the transaction appears in the broker's trust account(s). A notification email can be sent to the broker indicating the broker should view its bank account to locate the debit amount of the test transaction and then log in to confirm such amount, as illustrated in FIG. 15. A corresponding credit transaction in the same amount as the debit transaction is generated after the debit transaction has been verified, thereby balancing the broker's trust account. In some embodiments, the system does not auto-generate debit/credit transactions to the broker's operating account, but rather the initial service fee transaction that is processed is used to verify that account. The confirmation process is illustrated in FIG. 16.

Once the broker has entered the correct debit amount for the test transaction(s), the system can automatically activate the broker's account and enable the broker to complete all training videos, as illustrated in FIG. 17. Statuses, such as last viewed and last updated dates, can be displayed to the broker next to each training video to inform the broker which videos have and have not been viewed. The databases of both the MLS and the disclosed secure transaction system can be updated by displaying the disclosed secure transaction system's icon. This update can reflect that the broker is a Member in the disclosed transaction system.

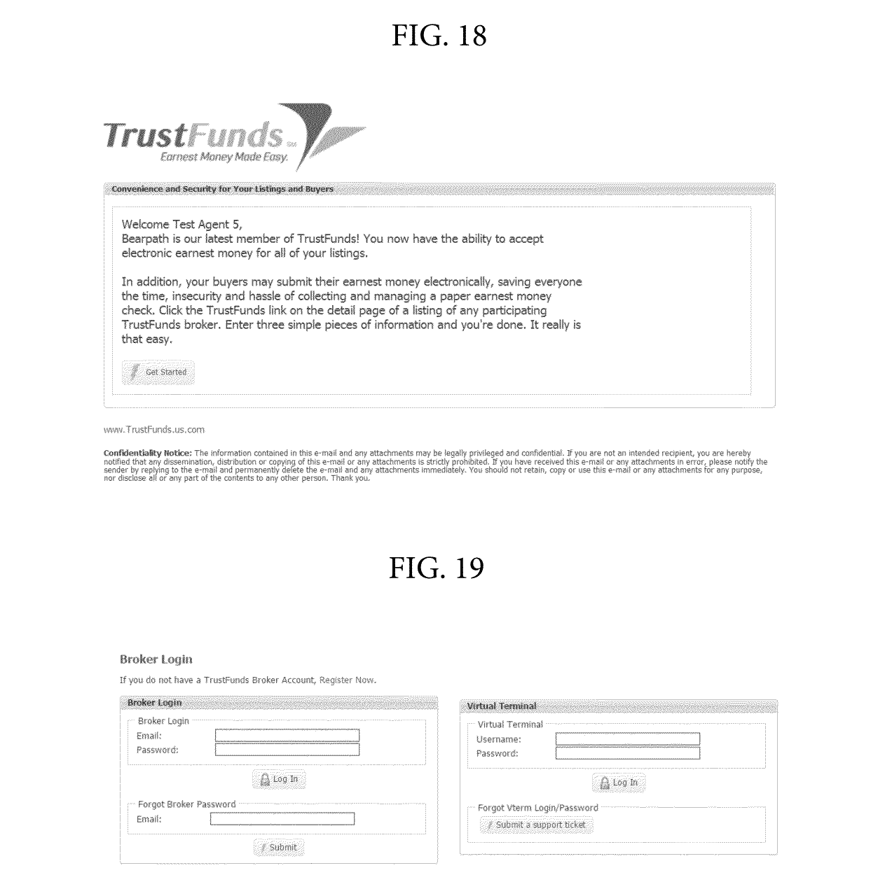

Upon completion of broker registration, the system can automatically activate the personal profiles of all of the broker's agents and the system can send system-generated emails, as illustrated in FIG. 18, to the agents. The emails can introduce the agents to the disclosed transaction system and notify them that their broker may now receive electronic earnest money payments.

Once the broker's account is activated, and thereafter, the broker can use the “Broker Login” box on the system's website by entering the email address and password established during registration with the disclosed secure transaction system, as illustrated in FIG. 19.

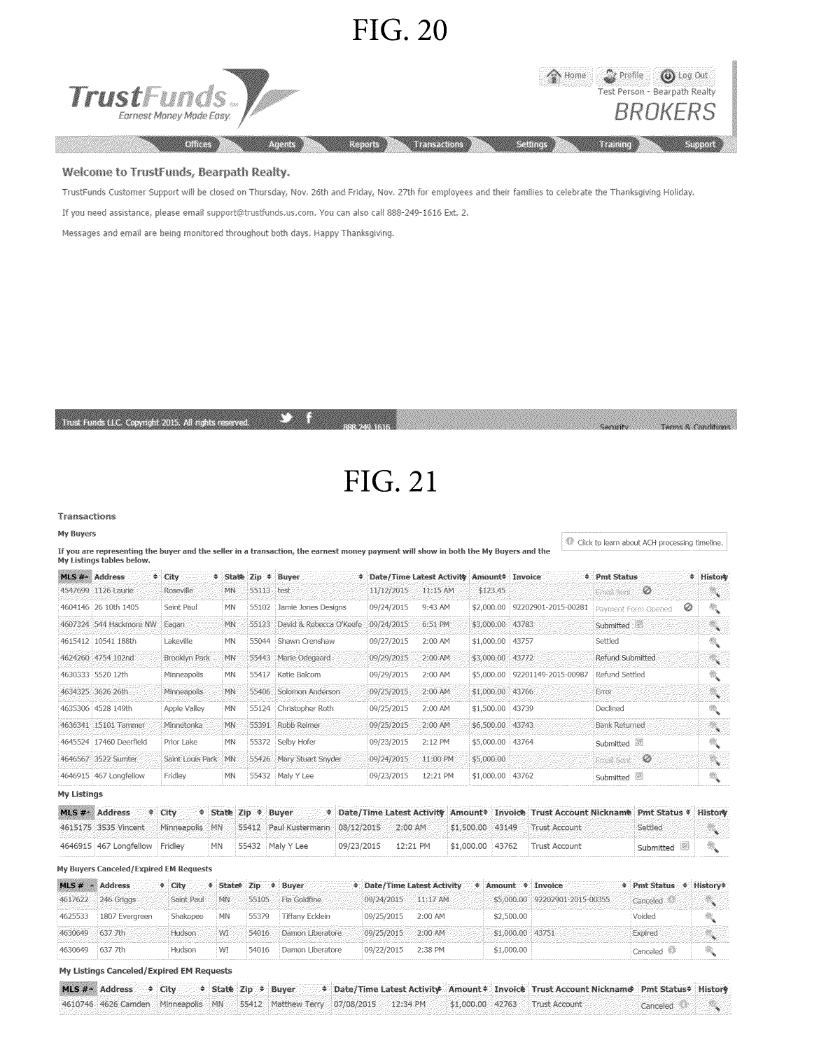

In some embodiments, once logged in, the broker lands on the Broker Home page, illustrated in FIG. 20. The Home page can contain shortcut icons. For example, a house icon can return the broker to the Home page from anywhere in the site, the person icon can allow the broker to update its profile, including email preferences and view its fee schedule, and the red circle icon can log the broker out of the disclosed secure transaction system.

Also illustrated in FIG. 20, a menu bar at the top of the Home page may exist and contain several action options. An Offices tab, when selected, can list all of the offices for the broker as provided from the MLS database. An Agents tab, when selected, can list all of the agents associated with the broker as provided from the MLS database. A Reports tab, when selected, can provide the broker with a dashboard including metrics to measure the adoption of the disclosed transaction system. A Transactions tab, when selected, will present a broker with several options and is described below. The available options provided by selecting a Settings tab is also described below. A Training tab, when selected, can include links to all training materials. A Support tab, when selected, can provide contact information for the disclosed transaction system, including toll-free telephone, email, and the ability to submit a web ticket.

The Transactions tab, mentioned above, is a part of the system that a broker may utilize often, and it can contain at least two tables, as illustrated in FIG. 21. The “My Buyers” table lists earnest money payments that have been made by the buyers of the broker. The “My Listings” table lists earnest money payments made by buyers for properties listed by the broker.

The “My Listings” table can include, in addition to a Trust Account Nickname for the trust account into which the earnest money payment was deposited, the MLS number, the street address, city, state and zip, the buyer's name, and various transaction data such as, but not limited to, the date and time of the latest activity, the amount of the earnest money payment, the invoice number, and the payment status. The Trust Account Nickname may be a critical feature for those brokers that have more than one trust account, and it can provide the broker with a visual confirmation of which trust account received a specific earnest money payment. The records in both tables can be displayed chronologically using the MLS number and the list can include all, or a portion, of the earnest money payment transactions that have occurred. Brokers may sort the data by a specific column or may filter the data using various filter options. For example, a broker can sort the data by searching for transactions for a specific office or a broker can enter a specific MLS number to locate a single record. Both tables can display an indicator of Payment Status, as more fully described below, along with the date and time of the last activity. There is also an explanation of the ACH processing timeline. For the transactions in a ‘Submitted’ status, there may be a mouse-over calendar icon that can display an expected settlement date.

The various payment statuses include, but are not limited to, “Email Sent,” “Payment Form Opened,” “Submitted,” “Settled,” “Returned,” “Canceled,” “Refund Submitted,” “Refund Settled,” “Error,” “Declined,” “Expired,” “Bank Returned,” and “Voided.”

The payment status “Email Sent,” means the buyer's agent sent the Earnest Money Request to the buyer. The agent can do this via an email generated by the disclosed transaction system that includes an embedded link, which, when clicked, brings the buyer to a payment form that allows the buyer to make the earnest money payment.

The payment status “Payment Form Opened,” means the buyer has opened the above-described email and clicked through to view the payment form, but has not yet submitted the earnest money payment.

The payment status “Submitted,” means the buyer has used the system to submit the electronic earnest money payment. The payment status will remain in Submitted status until the payment is settled.

The payment status “Settled,” indicates the buyer's earnest money payment has deposited to the designated trust account.

The payment status “Returned,” indicates the earnest money payment was returned to the buyer's bank. This feature is a valuable tool for both agents and brokers because it provides real-time information about the buyer's earnest money payment. Therefore, agents and brokers, upon seeing this Payment Status, can more timely notify a seller that the earnest money did not deposit to the designated trust account.

The payment status “Canceled,” can be displayed if the buyer's agent cancels the Earnest Money Request before the buyer has submitted the payment. In some embodiments, the system can ask for information related to the reason for the cancellation to track the issue(s). Examples of when a cancellation may be used is if the wrong amount of earnest money or the incorrect email address was originally included in the Earnest Money Request.

The payment status “Refund Submitted” or “Refund Settled,” can be displayed if the broker electronically processes a refund.

The payment status “Error” or “Declined,” can be displayed if the buyer has experienced a failure during an attempt to submit their earnest money payment. Such reasons may include invalid routing number or Internet interruption.

The payment status “Expired,” can be displayed if the buyer does not submit the earnest money payment within seven (7) calendar days of the Earnest Money Request.

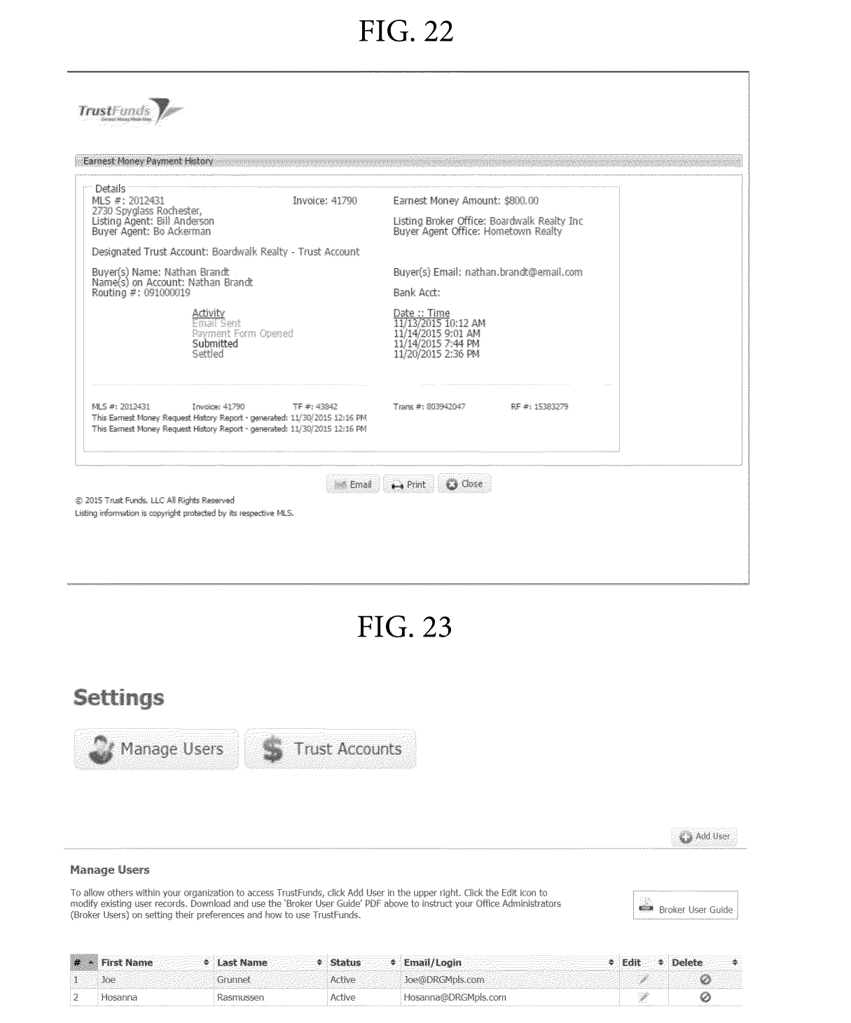

As illustrated in FIG. 21, an Earnest Money Payment History report is available by clicking on an icon, such as the magnifying glass icon. The Earnest Money Payment History Report, an example of which is illustrated in FIG. 22, can include information about the property, the amount of the earnest money payment, the names of the agents and brokers for both sides of the transaction, the designated trust account, information about the buyer, the buyer's bank account, and the date and time of each step of the payment process. In addition, the Payment History Report may be emailed directly to a lender to document the earnest money payment. Brokers may not use the Transactions page, the Payment History, or any email notifications to reconcile trust account(s). Bank reconciliation and other transaction functions are, in a preferred embodiment, managed in the system's Virtual Terminal.

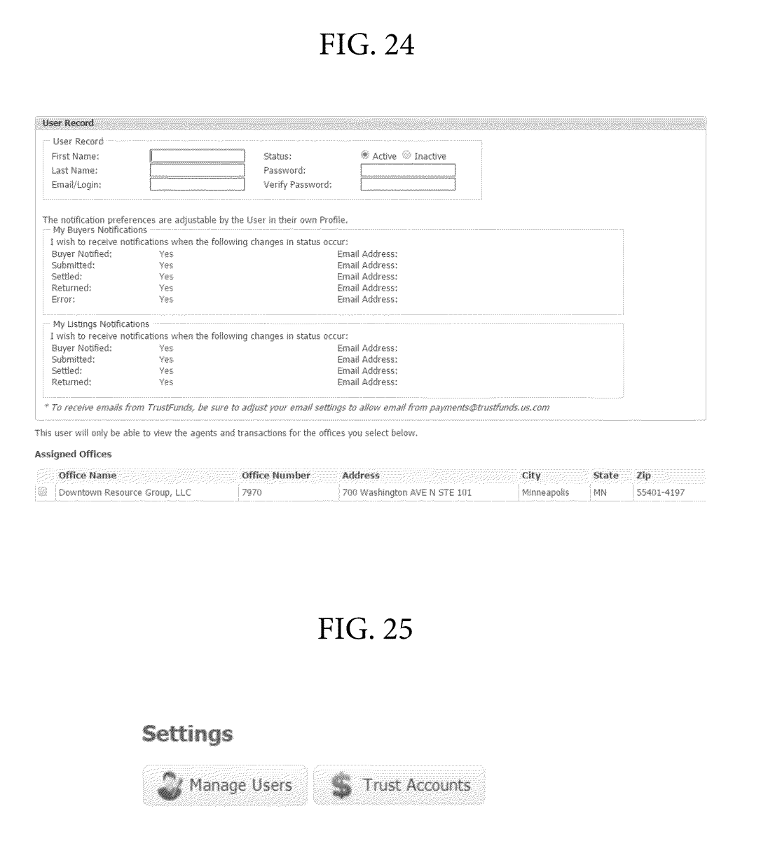

In the Settings tab, brokers can manage their users, as illustrated in FIG. 23. For example, brokers can grant individuals in the organization permission to view pre-determined transaction data in the system. In some embodiments, as illustrated in FIG. 24, brokers can grant permission by clicking on the “Add User” button to add a user, completing the user record, and selecting the broker's offices to which the broker wants the user to have access. After taking these steps, the system can filter the data to display information pertinent only to those office(s) to which the new user has access. In addition, brokers can edit or delete existing users. Access to these options gives brokers complete control over which users see what transaction data.

As discussed earlier, the disclosed secure transaction system is a unique system that allows buyers to deposit earnest money payments to a designated trust account, and if a broker has more than one trust account, the system software properly identifies the correct account. As an added feature, the disclosed system allows brokers to review all of its trust accounts by clicking on the “Trust Account” button, illustrated in FIG. 25.

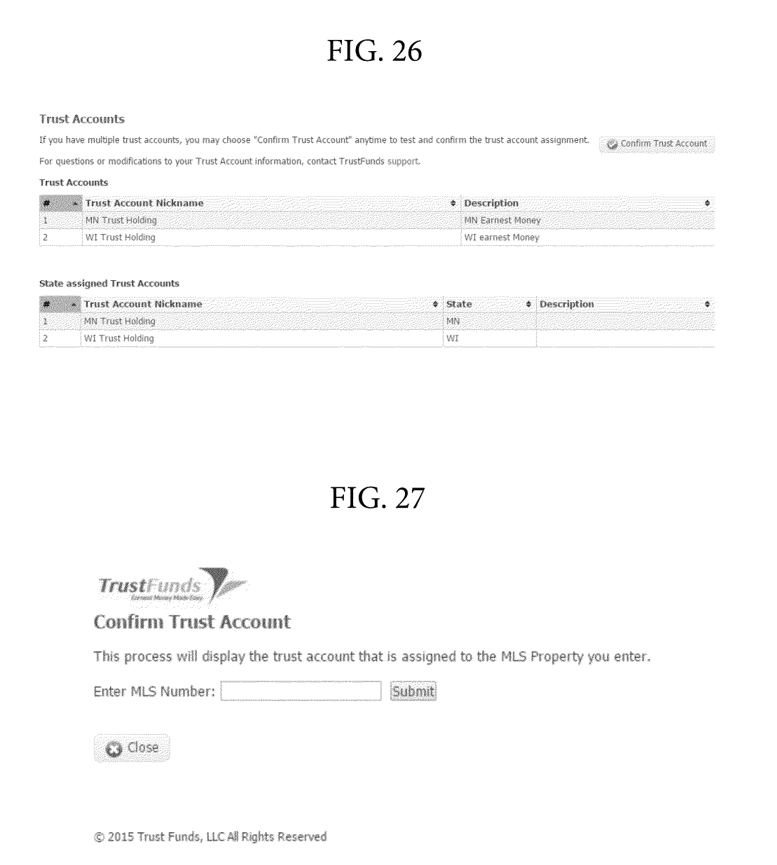

In some embodiments, after selecting the “Trust Account” button, the system will display the Trust Account page, illustrated in FIG. 26, to the user. The Trust Account Page can display all of a broker's trust accounts by nickname along with a description of which earnest money payments should be deposited into each account. The disclosed secure transaction system can identify the correct trust account for an earnest money deposit by using information and criteria previously set for each broker. The different types of trust accounts that the disclosed secure transaction system can identify include: (1) a specific trust account based on the MLS number of the property (this includes information in the system that can block earnest money transactions for specific properties); (2) a single trust account; (3) a specific trust account based on both the physical location of the property by state and the designated trust account holder's office location; (4) a specific trust account based on the designated trust account holder's office location; and (5) a specific trust account based on physical location of the property, as illustrated in FIG. 1.

As another added security feature, the system can allow a broker to confirm that a specific earnest money payment is “tied” to the correct trust account by clicking on the “Confirm Trust Account” button, as illustrated in FIG. 26. The system operates this feature by running the above-described algorithm program to determine and display the correct trust account for a specific MLS number.

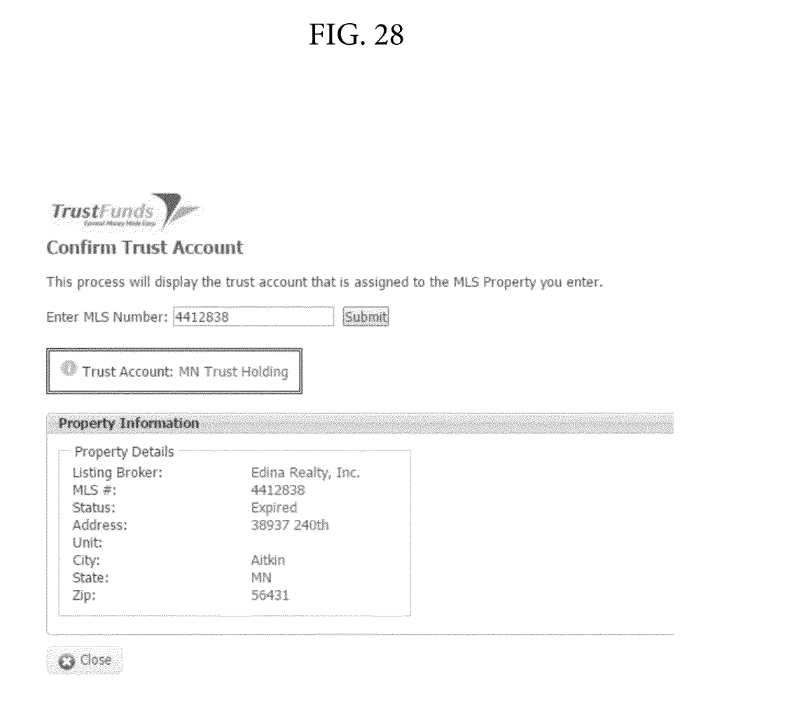

To confirm a correct trust account, the broker can enter an MLS number of one of the broker's listings and click on “Submit,” as illustrated in FIG. 27. The system can then return identification of the trust account to the broker for verification that it is correct, as illustrated in FIG. 28.

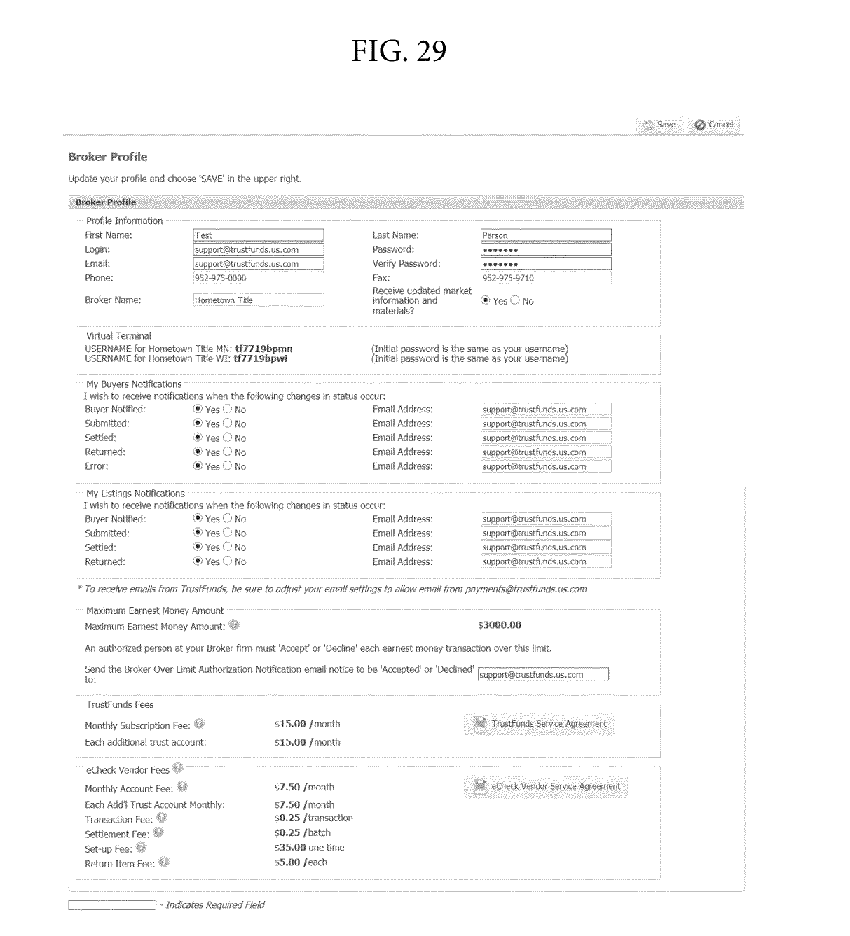

In its profile, a broker can make a selection for which email notifications it wishes the system to send, and it can specifically identify the person(s) to receive such email notifications. These notification preferences may be customized for the broker's buyers' transactions and for the broker's listings' transactions, as illustrated in FIG. 29.

Brokers may also subscribe to use the disclosed system's Virtual Terminal service to process other types of transactions from their operating account. In doing so, the Virtual Terminal can be an effective tool for brokers to process debit and credit transactions of any nature in the operation of their business.

Other Designated Trust Account Holders

In addition to real estate brokers, buyers may use the disclosed transaction system to submit their earnest money payment to other designated trust account holders such as title companies, escrow companies, and law firms.

Designated trust account holders that wish to receive electronic earnest money payments for transactions as part of their business model must also register with the disclosed secure transaction system and pay a monthly subscription fee. The fee is a sliding scale based on the number of closings performed in the previous year. In order for the designated trust account holder to receive earnest money payments through the system, they can use the disclosed secure transaction system's ACH Processor to activate an ACH processing account for each of the trust accounts to which the designated trust account holder wishes to receive earnest money payments.

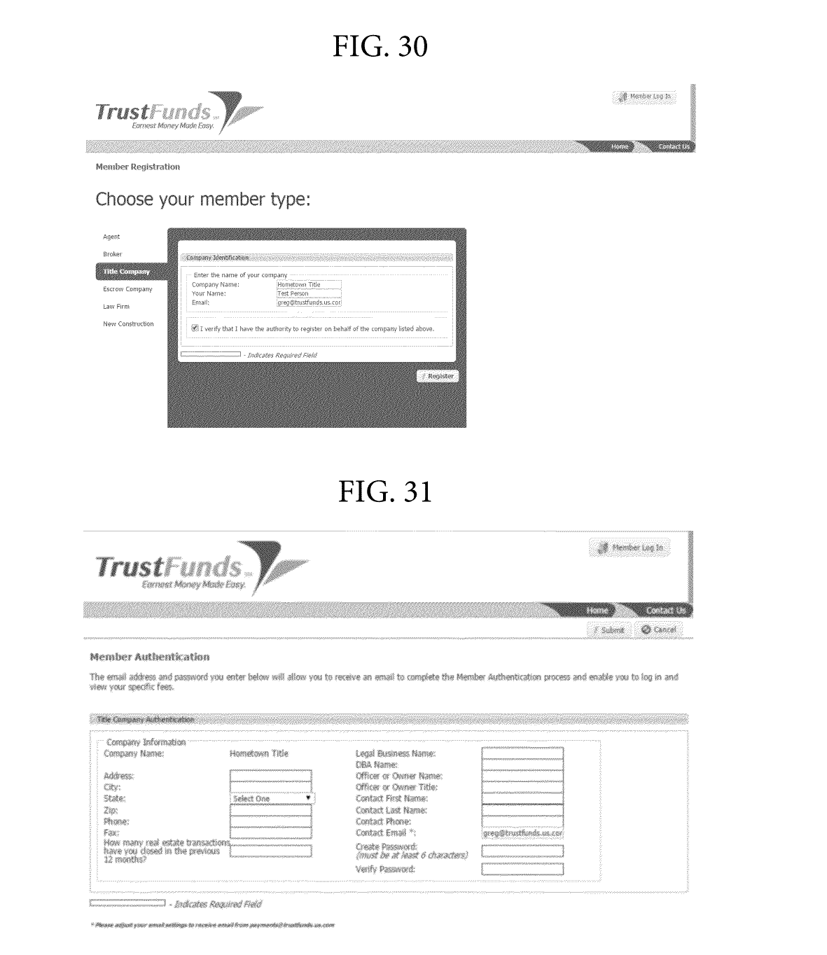

A designated trust account holder can register to use the disclosed transaction system by first selecting the appropriate Member Type, such as title company, and providing the required company information, as illustrated by FIG. 30, such as company name, user's name, and user's email address. Next the designated trust account holder can complete the Member Authentication by entering additional company information, as illustrated in FIG. 31. The company information requested can include address, city, state, zip, phone number, fax number, the number of real estate closings in the previous twelve (12) months, legal business name, DBA name, officer or owner name, officer or owner title, contact's first name, contact's last night, contact's phone number, contact's email address, and a newly created password.

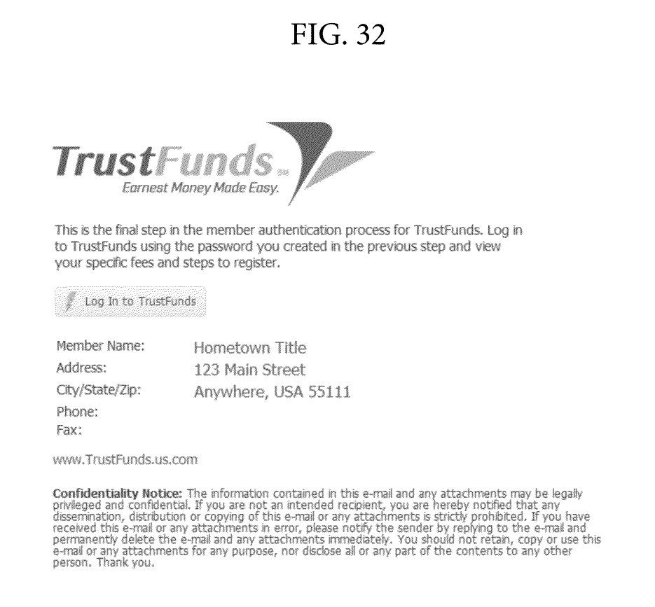

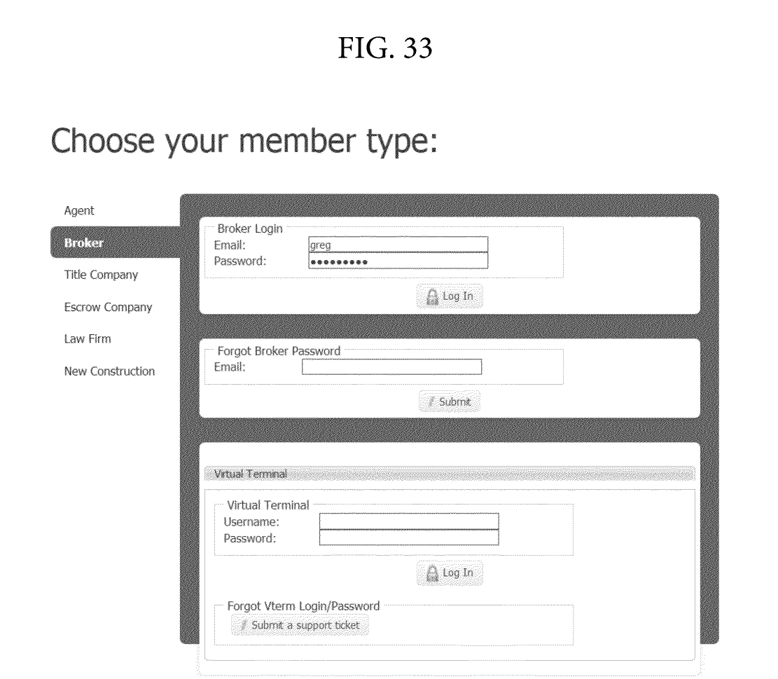

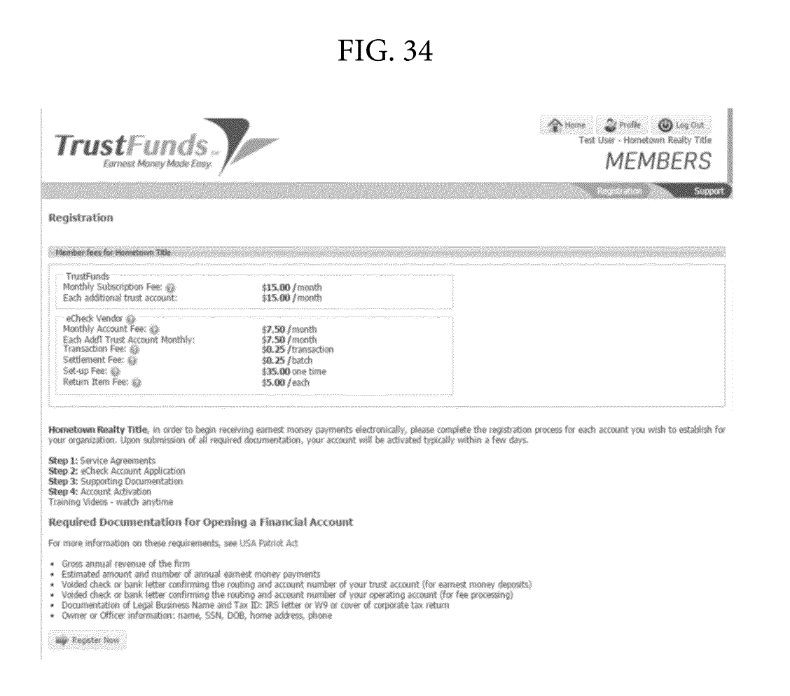

In some embodiments, after the designated trust account holder provides the above-described information, the designated trust account holder will receive a confirmation email at the email address the designated trust account holder provided. The email can provide a link, illustrated in FIG. 32, that will enable the designated trust account holder to log in and finalize the authentication process, as illustrated in FIG. 33. Once authenticated, the designated trust account holder can be presented with all applicable fees (which are determined from the reported number of annual real estate transactions) and a summary of the registration steps along with a checklist of the documentation required for opening a financial account, as illustrated in FIG. 34.

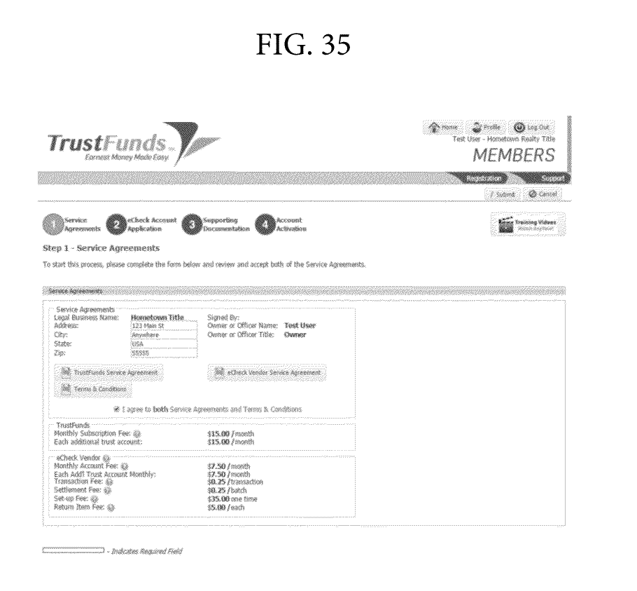

In some embodiments, Step 1, illustrated in FIG. 35, permits the designated trust account holder to review and accept the terms of the service agreements of the disclosed transaction system and the ACH vendor, as well as the Terms and Conditions.

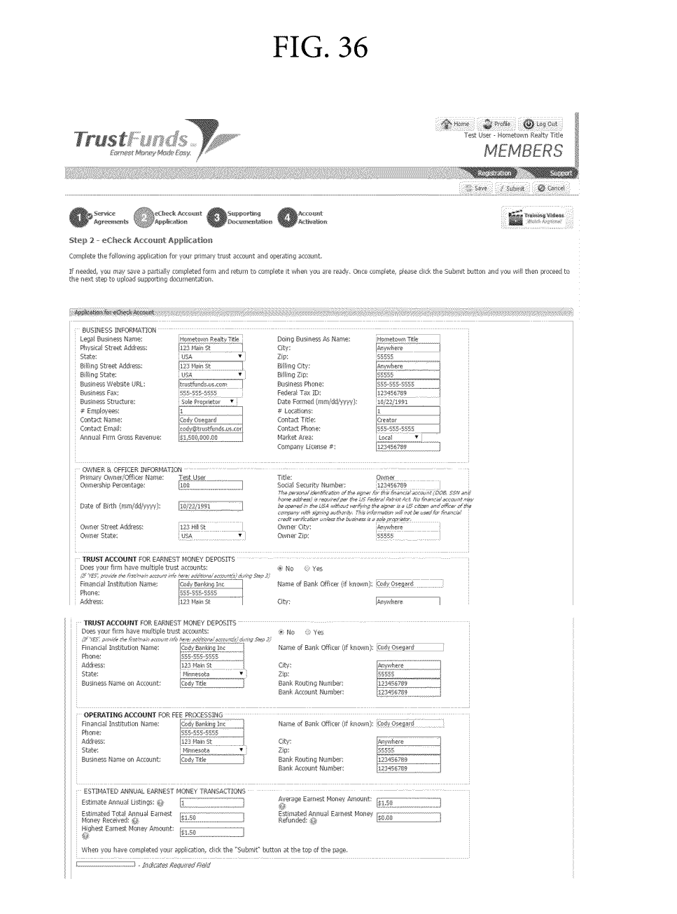

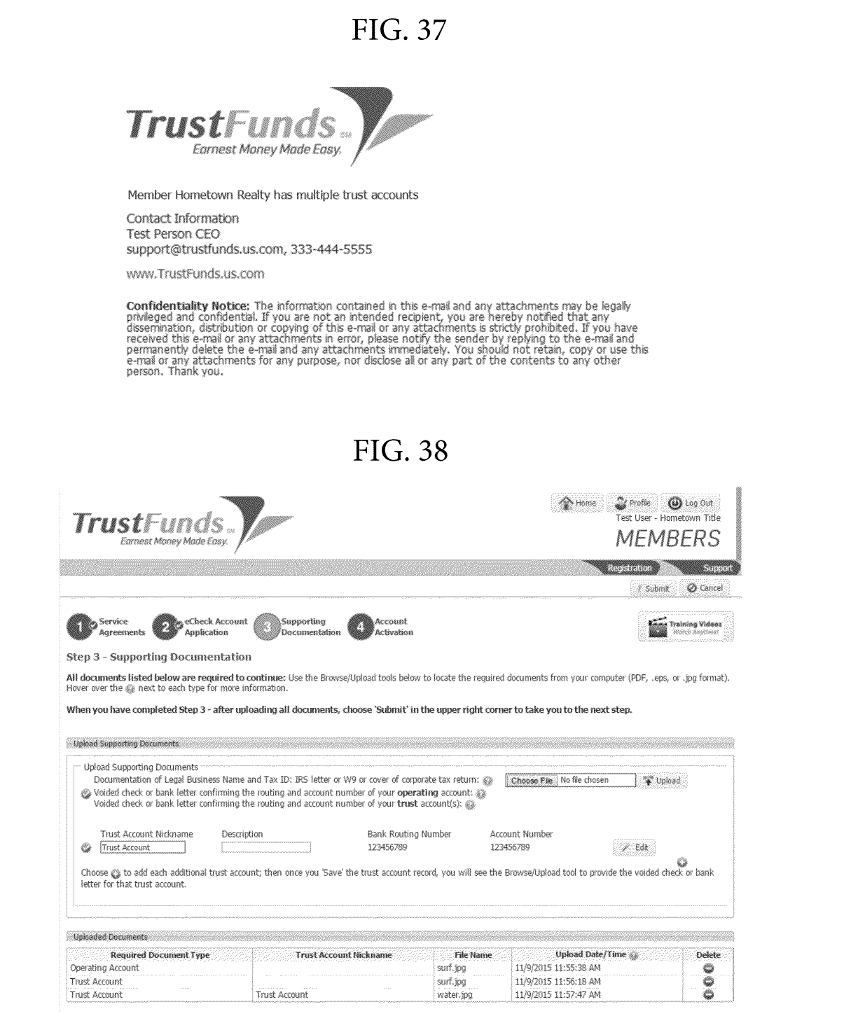

In some embodiments, Step 2, illustrated by FIG. 36, enables the designated trust account holder to provide the information required to activate an ACH account, which enables the designated trust account holder to receive electronic earnest money payments into a designated trust account(s). As part of the application, the designated trust account holder can indicate whether its organization has more than one trust accounts. If the designated trust account holder has more than one trust account, it can open an ACH account for each trust account. Earnest money payments to the proper trust account are based upon the system's algorithm, as described earlier. If the designated trust account holder responds with a “Yes” to multiple trust accounts, a notification is sent to the disclosed secure transaction system's support staff, as illustrated in FIG. 37, to provide the designated trust account holder with a Multiple Trust Account form to define how the trust accounts are managed within the designated trust account holder's organization.

In some embodiments, Step 3, illustrated in FIG. 38, enables the designated trust account holder to upload the required supporting documentation for the trust account(s) and the designated trust account holder's operating account so the ACH account(s) can be underwritten. The disclosed secure transaction system allows the designated trust account holder to upload documents of each type for all accounts.

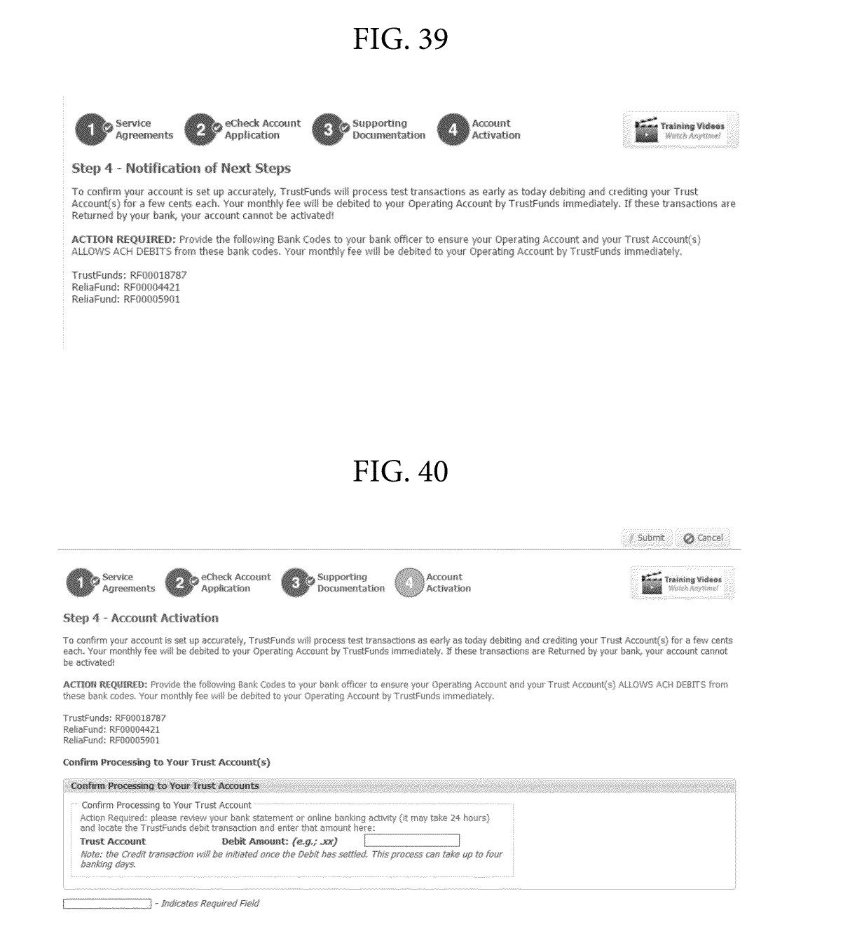

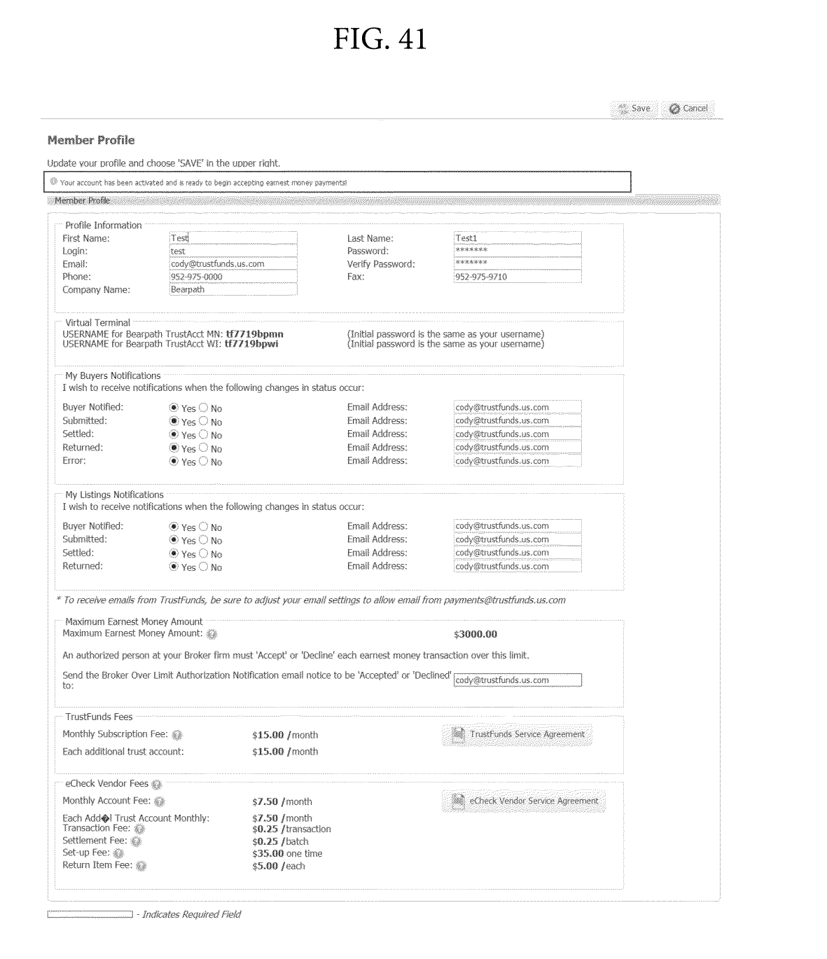

In some embodiments, the final step is Step 4, which can be a two-part process. First, as illustrated in FIG. 39, the designated trust account holder can be advised that the account activation is in process and that the designated trust account holder must wait until the ACH account is activated. Once activated, the system can proceed to the second part of Step 4, wherein the system auto-generates a debit transaction of a random dollar amount to each trust account to ensure the transaction appears in the trust account(s). A notification email can be sent to the designated trust account holder indicating the designated trust account holder should view its bank account to locate the debit amount of the test transaction and then log in to confirm such amount, as illustrated in FIG. 40. A corresponding credit transaction in the same amount as the debit transaction is generated after the debit transaction has been verified, thereby balancing the designated trust account holder's trust account. In some embodiments, the system does not auto-generate debit/credit transactions to the designated trust account holder's operating account, but rather the initial service fee transaction that is processed is used to verify that account. The confirmation process is illustrated in FIG. 41.

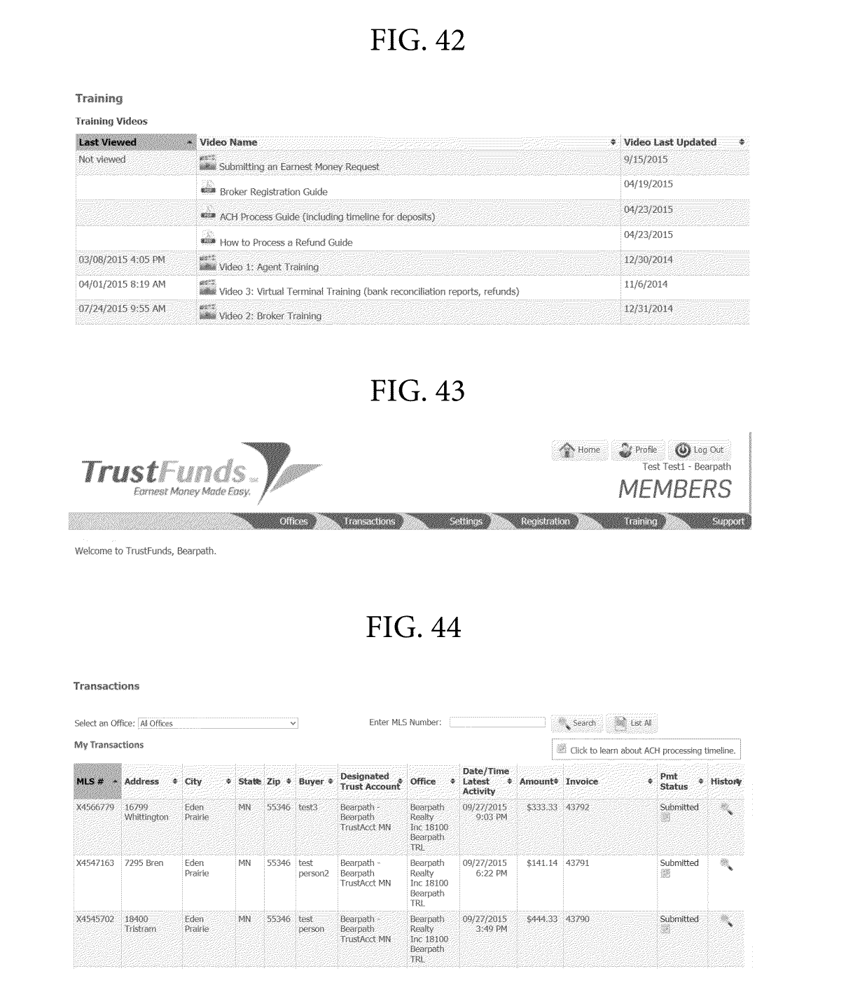

Once the designated trust account holder has entered the correct debit amount for the test transaction(s), the system can automatically activate the designated trust account holder's account and enable the designated trust account holder to complete all training videos, as illustrated in FIG. 42. Statuses, such as last viewed and last updated dates, can be displayed to the designated trust account holder next to each training video to inform the designated trust account holder which videos have and have not been viewed. The database of the secure transaction system can be updated by displaying the disclosed secure transaction system's icon. This update can reflect that the designated trust account holder is a Member in the disclosed transaction system.

Once the designated trust account holder's account is activated, and thereafter, the designated trust account holder can use the “Member Login” box on the system's website by entering the email address and password established during registration with the disclosed secure transaction system, as illustrated in FIG. 32.

In some embodiments, once logged in, the designated trust account holder lands on the Member Home page, as illustrated in FIG. 43. The Home page can contain shortcut icons. For example, a house icon can return the user to the Home page form anywhere in the site, the person icon can allow the user to update its profile, including email preferences and view its fee schedule, and the red circle icon can log the user out of the disclosed secure transaction system.

Also illustrated in FIG. 43, a menu bar at the top of the Home page may exist and contain several action options. An Offices tab, when selected, can list all the offices for the designated trust account holder provided by the designated trust account holder. A Reports tab, when selected, can provide the designated trust account holder with a dashboard including metrics to measure the adoption of the disclosed transaction system. A Transactions tab, when selected, will present a designated trust account holder with several options and is described below. The available options provided by selecting a Settings tab are the same as for a broker, as more fully described earlier. A Training tab, when selected, can include links to all training materials. A Support tab, when selected, can provide contact information for the disclosed transaction system including toll-free telephone, email, and the ability to submit a web ticket.

The Transactions tab, mentioned above, is a part of the system that a designated trust account holder may utilize often. When a user selects the Transactions tab, the system may display a Transaction table, which may list earnest money payments that have been made by buyers and deposited to the designated trust account holder's trust account, as illustrated in FIG. 44.

The Transaction table can include, in addition to the Trust Account Nickname for the trust account in which the earnest money payment is deposited, the MLS number, the street address, city, state and zip, the buyer's name, and various transaction data such as, but not limited to, the office, the date and time of the latest activity, the amount of the earnest money payment, the invoice number, and the payment status. The Trust Account Nickname may be a critical feature for those designated trust account holders who have more than one trust account, and it can provide the user with a visual confirmation of which trust account received a specific earnest money payment. The records in the table can be displayed chronologically using the MLS number and the list can include all, or a portion, of the earnest money payment transactions that have occurred. Designated trust account holders may sort the data or may filter the data using various filter options. For example, a designated trust account holder can sort the data by searching for transactions for a specific office or a designated trust account holder can enter a specific MLS number to locate a single record. The transaction table can display an indicator of Payment Status along with the date and time of the last activity. There is also an explanation of the ACH processing timeline, and there may be a mouse-over calendar icon that can display an expected settlement date for transactions in a ‘Submitted’ status.

The various payment statuses such as ‘Email Sent’, ‘Payment Form Opened’, ‘Submitted’, ‘Settled’, ‘Returned’, ‘Canceled’, ‘Refund Submitted’, ‘Refund Settled’, ‘Error’, ‘Declined’ and ‘Expired’ are the same as they are for the broker as described above. Additionally, the Earnest Money History Report and access to it are the same as described earlier for brokers.

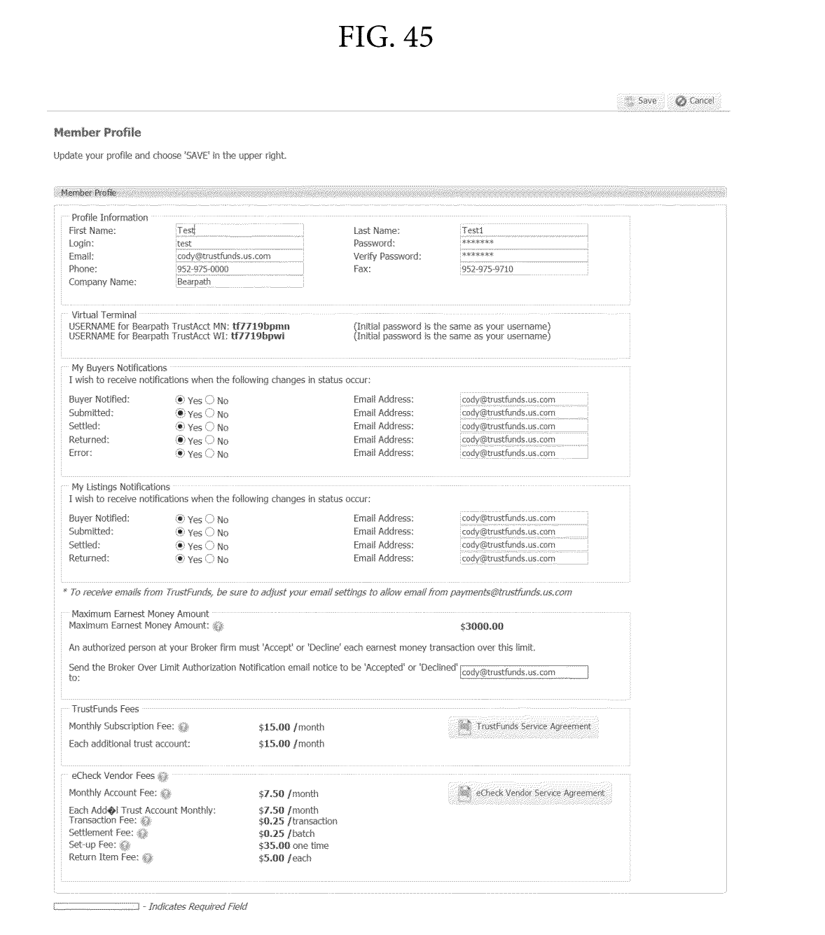

In its profile, a designated trust account holder can make a selection for which email notifications it wishes the system to send, and it can specifically identify the person(s) to receive such email notifications, as illustrated in FIG. 45.

Designated trust account holders may also subscribe to use the disclosed system's Virtual Terminal service to process other types of transactions from their operating account. In doing so, the Virtual Terminal can be an effective tool to process debit and credit transactions of any nature in the operation of their business.

Agents and Buyers

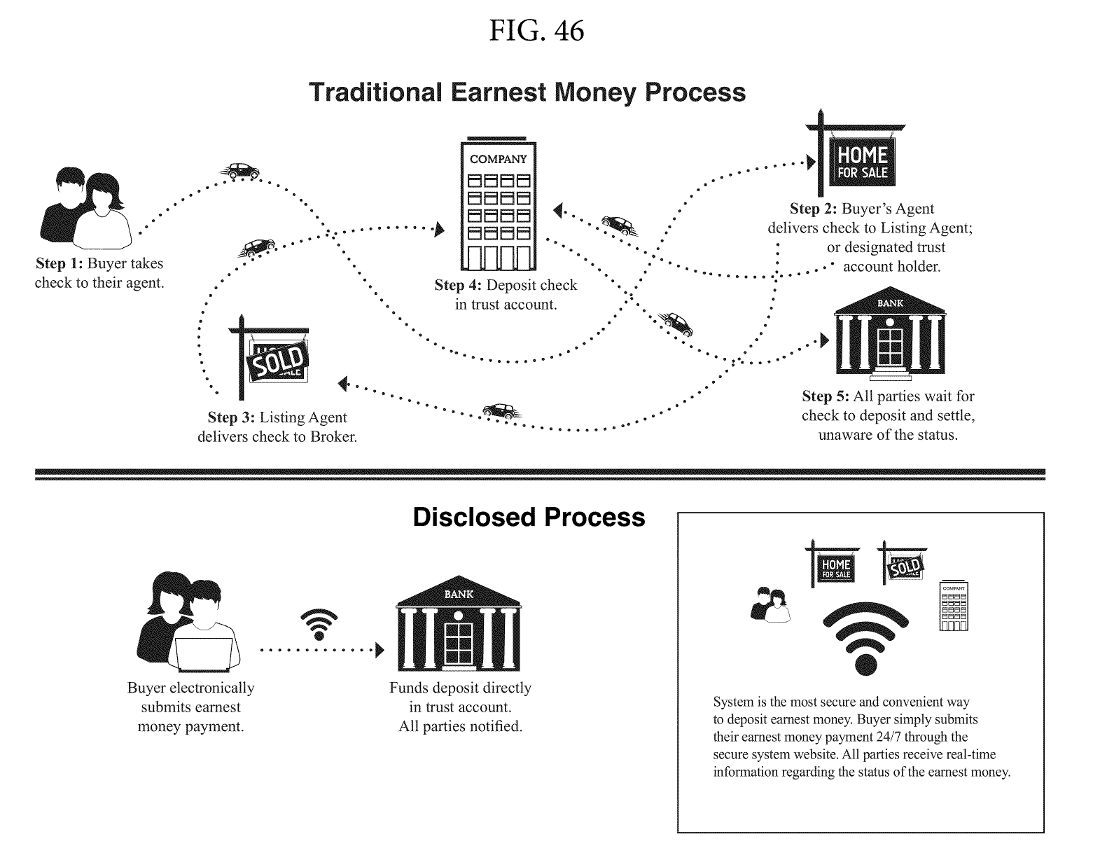

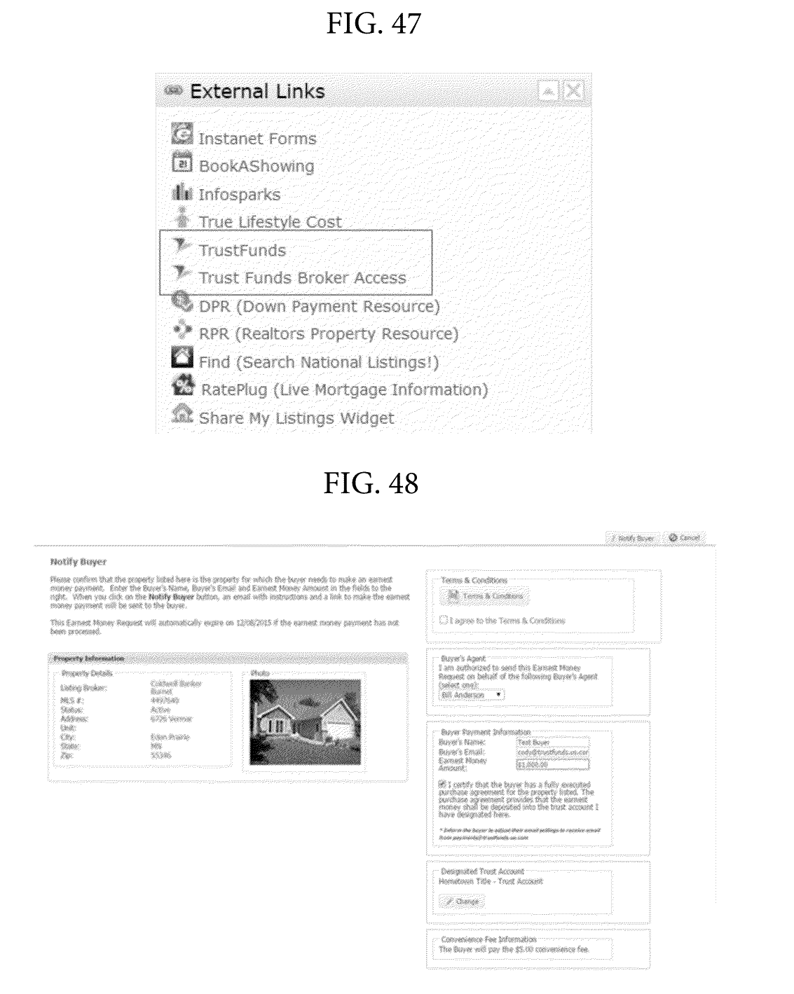

As described above, the disclosed secure transaction system, as illustrated in FIG. 46, revolutionizes the antiquated method of physically delivering paper earnest money checks as part of real estate transactions. More specifically, the traditional earnest money process involves a buyer taking a check to his or her agent and the buyer's agent delivering the check to a listing agent or other designated trust account holder. If delivered to the listing agent, the traditional earnest money process involves the listing agent delivering the check to the broker, the broker depositing the check into a trust account, and all parties waiting for the check to deposit and settle while remaining unaware of the status of the pending transaction. In the disclosed system, the process is streamlined and all parties can receive real-time information regarding the status of the earnest money. More specifically, a buyer can electronically submit his or her earnest money payment and the funds can be deposited directly into the trust account. Agents can access the disclosed system via single-sign-on (“SSO”) technology directly from the applicable MLS system. The home page of the MLS system can display an icon for access to the disclosed transaction system, as illustrated in FIG. 47.

In some embodiments, real estate agents can use the disclosed transaction system to receive earnest money payments even if their broker has not subscribed to the system. This enables agents to send an Earnest Money Request and enables buyers to submit their earnest money payment to any designated trust account holder that has subscribed to the system.

As each new MLS market is launched, all of the agents can be automatically registered. Agents may simply confirm the details of their profile by clicking on the disclosed transaction system's icon on, for example, the home page of the MLS. In some embodiments, the first time the agent generates an Earnest Money Request, the agent can be prompted to accept the Terms and Conditions, as illustrated on FIG. 48.

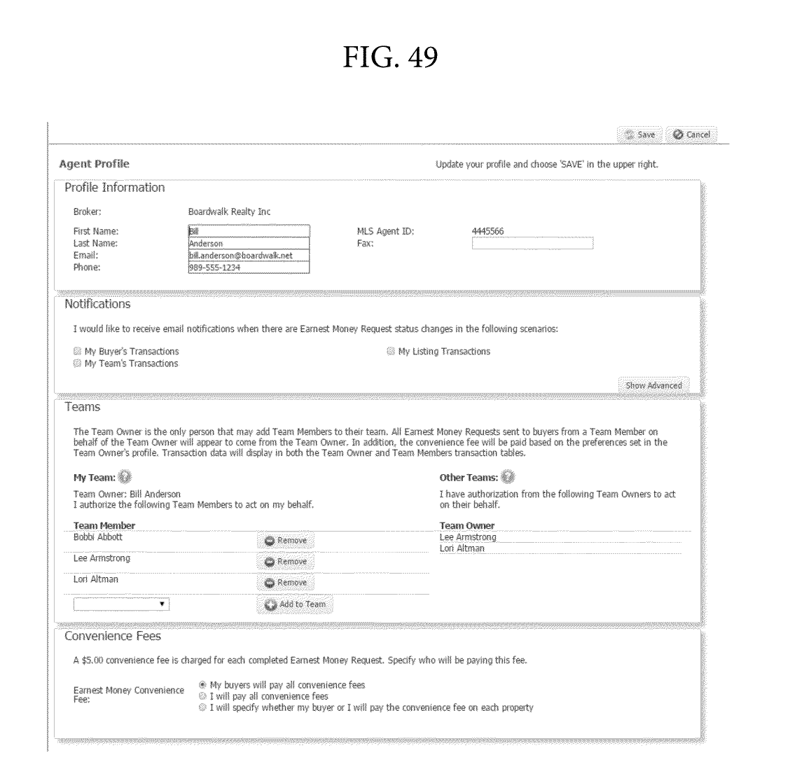

In an agent's personal profile, as illustrated in FIG. 49, the agent can select which email notifications the agent wishes to receive from the system. The default setting may be to receive all notices, and there may be an option to customize the email settings under the ‘advanced’ setting. Additionally, the agent profile can indicate the preference to either have the buyer pay the convenience fee or have the agent occasionally or always pay the convenience fee for each earnest money payment. The default setting for the convenience fee can be for the buyer to pay. If the agent elects to have the buyer always pay the convenience fee, the system may not require the agent to provide any personal banking information. If, however, the agent elects to always pay the convenience fee, or elects on a case-by-case basis whether to pay the convenience fee, the system may require the agent to enter his or her personal bank account information into his or her profile, as illustrated in FIG. 49. The agent's bank account can be verified via an automated debit/credit transaction that is confirmed in a similar manner to the broker's and designated trust account holder's trust accounts. In some embodiments, if the account is not activated, the buyer will be asked to pay the convenience fee.

To support how the real estate industry operates in various markets, agents may have the option in their personal profile to designate other agents or assistants within their company to be part of their team. In some embodiments, an agent can create a team by searching and selecting from an available list of other agents in their company, as illustrated in FIG. 49. This team function allows authorized individuals to initiate Earnest Money Requests on behalf of the authorizing agent and, in some embodiments, to view the earnest money transaction data. Each team member can continue to maintain preferences in his or her profile regarding email notifications. However, the convenience fee payment for an earnest money transaction may be governed by the preference set by the authorizing agent in the authorizing agent's profile.

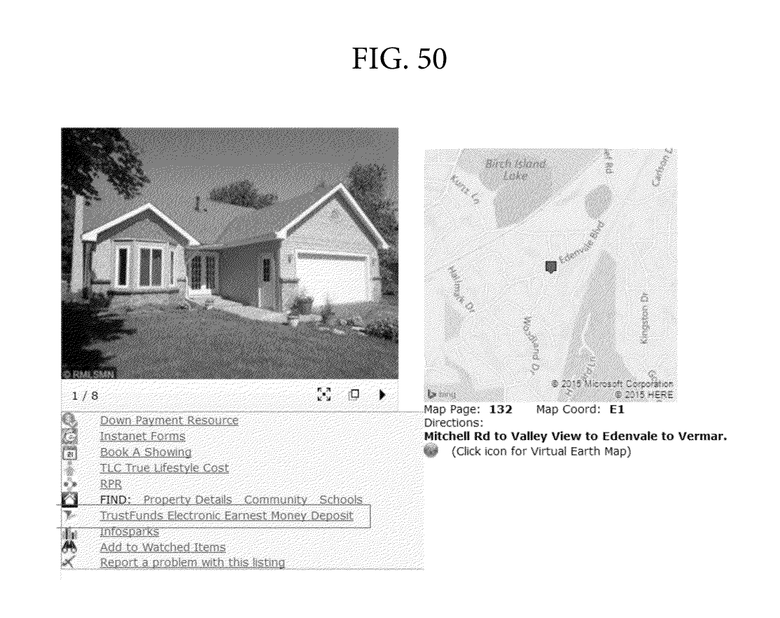

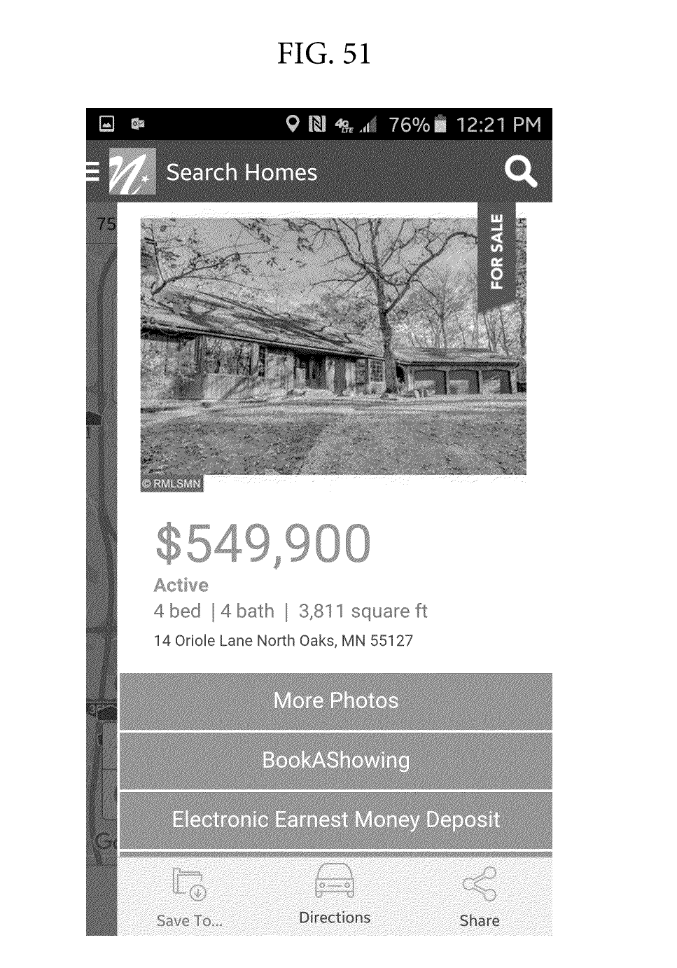

Upon final acceptance of a purchase agreement, the buyer's agent, as a Member of the disclosed secure transaction system, begins the electronic earnest money payment process by locating the property the buyer is interested in purchasing. The buyer's agent can locate the property by searching in the disclosed transaction system, the process of which will be more fully described below, by locating the property in the MLS web site, as illustrated in FIG. 50, or by locating the property in the MLS mobile application, as illustrated in FIG. 51.

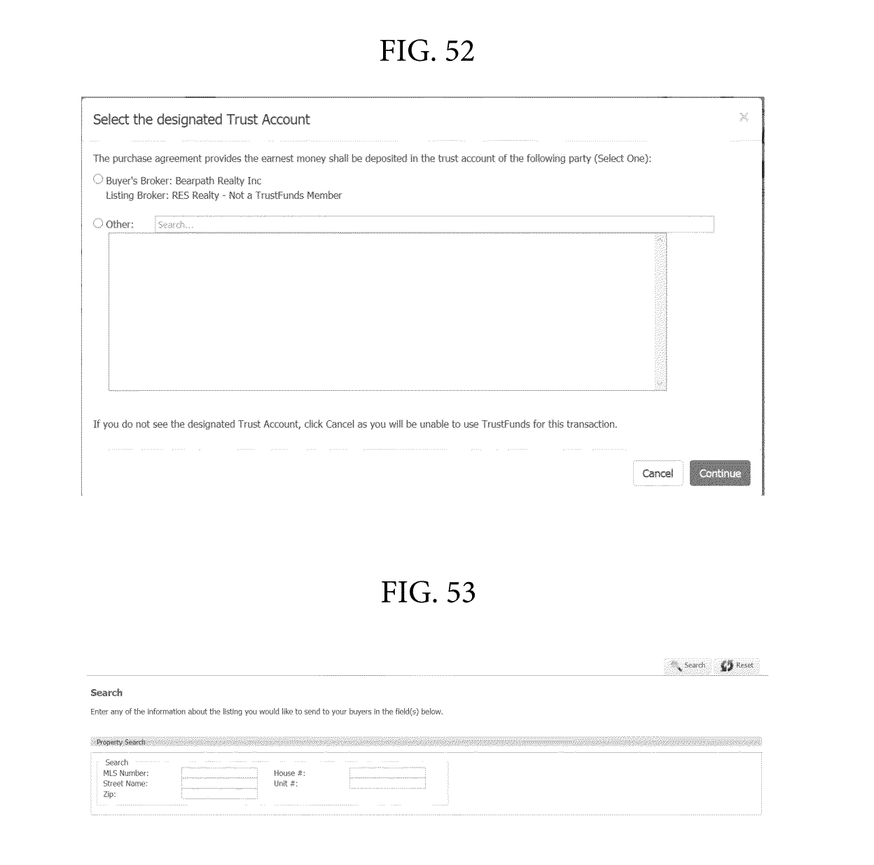

After the property is located, the buyer's agent can initiate the earnest payment process in the MLS system by selecting the disclosed secure transaction system icon on the property detail page for the property. In some embodiments, the link can direct the buyer's agent directly to the Earnest Money Request. In some embodiments, the link can direct the buyer's agent to a modal window, illustrated in FIG. 52, where the buyer's agent can select the required designated trust account holder that will receive the earnest money payment. The list of firms listed in the modal window will only include those firms that are Members of the disclosed secure transaction system and have ACH processing accounts that have been activated to receive electronic earnest money payments. If the buyer's broker and/or the listing broker are not Members of the system, they will be designated as such, as illustrated in FIG. 52.

Once the agent selects the required designated trust account holder, the agent can be directed to the Earnest Money Request Form within the disclosed secure transaction system, as illustrated in FIG. 55. The buyer's agent can enter the buyer's name(s), email address and the required amount of the earnest money the buyer agreed to submit as part of the purchase agreement. Additionally, the buyer's agent can certify that there is a fully executed purchase agreement between the buyer and seller of the property. The designated trust account holder and the payment of the convenience fee can also be displayed on this page. To send the Earnest Money Request to the buyer, the agent can click on the Notify Buyer button.

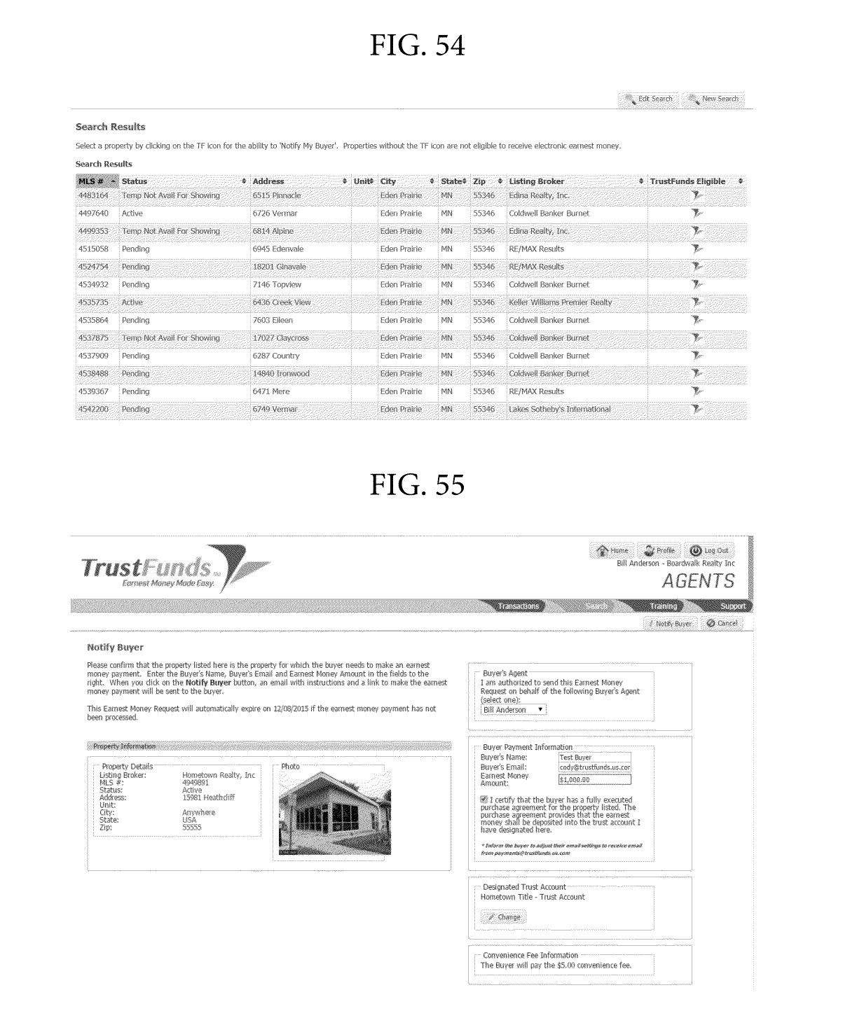

If the agent uses the database in the system to search for the property, as illustrated in FIG. 53, all properties matching the search criteria are displayed, as illustrated in FIG. 54. The agent can then select the listed property and the system can either direct the agent directly to the Earnest Money Request or direct the agent to a modal window and the Earnest Money Request, as described above and displayed in FIGS. 52 and 55.

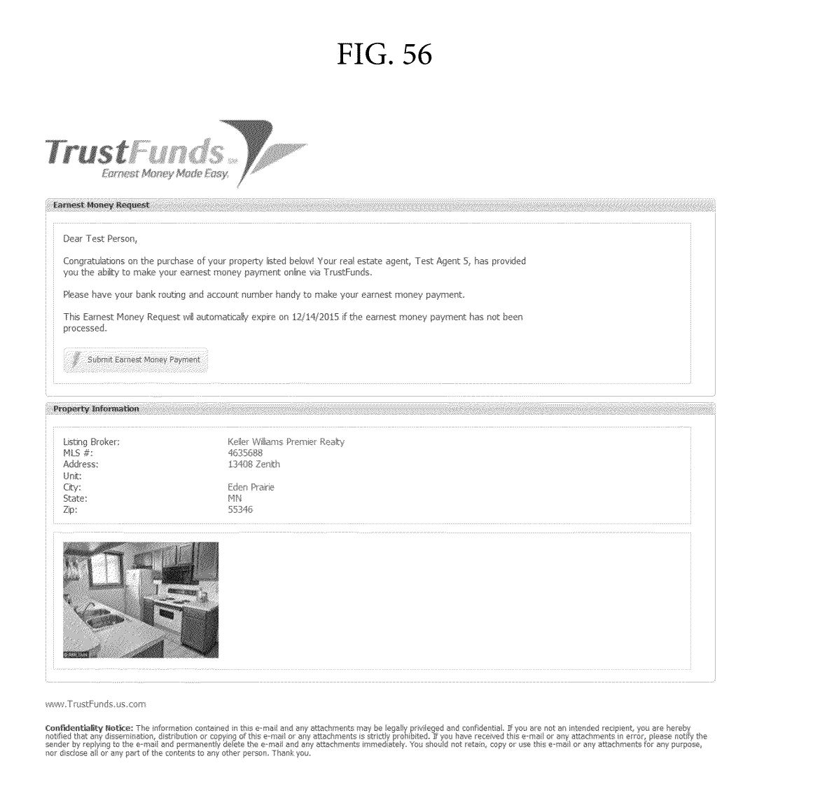

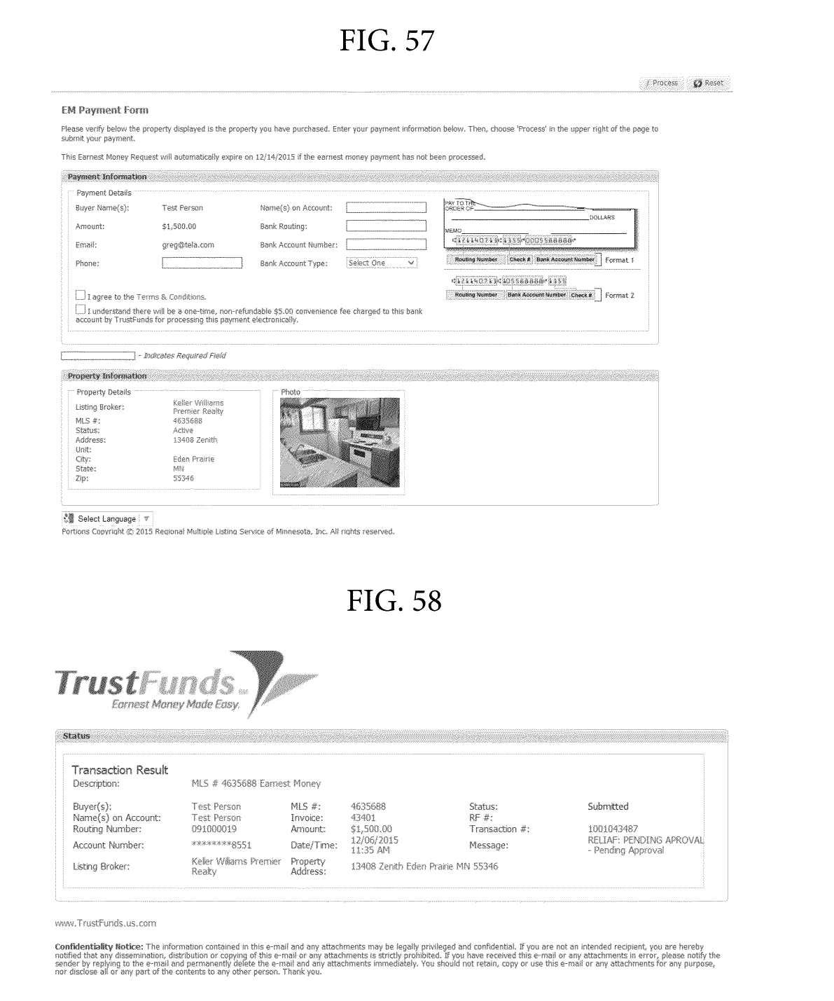

In some embodiments, as illustrated in FIG. 56, the disclosed secure transaction system can send the buyer an automated email that contains a secure, embedded link that the buyer can select to submit the earnest money payment. The Earnest Money Payment Form can be a web page pre-populated by the buyer's agent with the MLS property information and the amount of the earnest money payment required by the purchase agreement, as illustrated in FIG. 57. One of the pieces of MLS data provided to the buyer can be an actual photo of the property. This allows the buyer an easy visual confirmation that the buyer is submitting the earnest money payment for the property intended to be purchased. As illustrated in FIG. 57, the buyer can provide the additionally required information for the payment including phone number, name on bank account, bank routing number, and bank account number. Once completed, the buyer can select the Process button. The system can then display a transaction confirmation on screen and it can send the buyer an email confirmation, as illustrated in FIG. 58. In some embodiments, after the buyer has made an earnest money payment, the buyer has no further access to the disclosed secure transaction system. If the buyer has paid the convenience fee, the buyer may receive a second receipt for that payment.

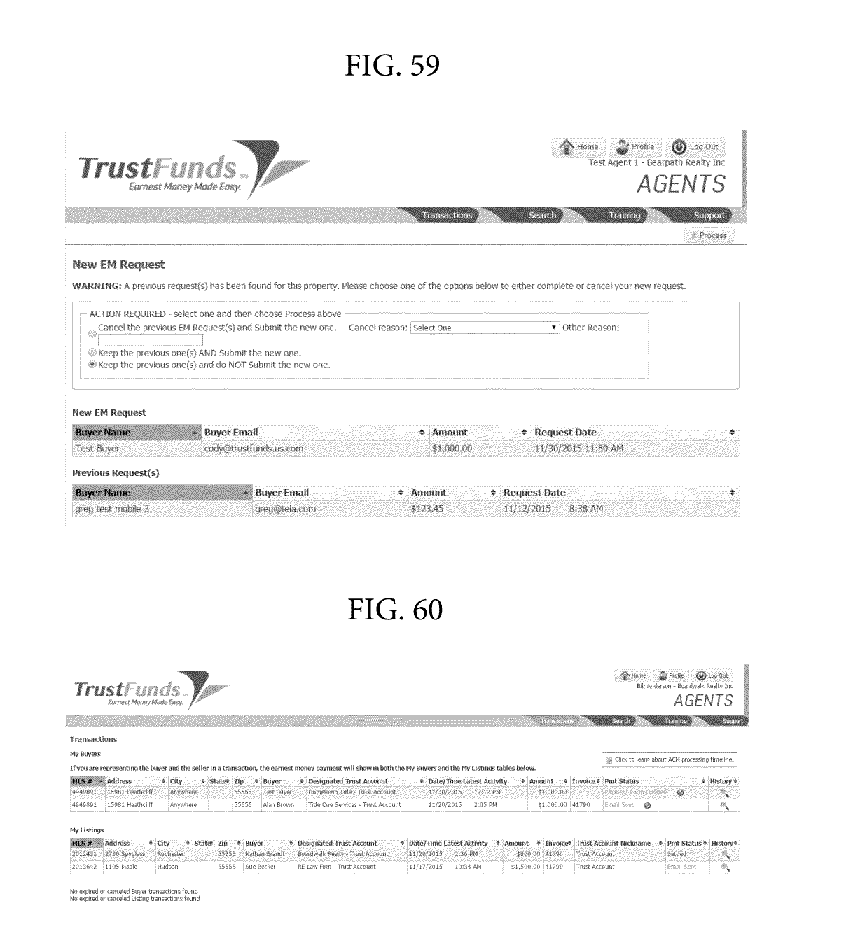

In the event the buyer's agent sends the buyer a New Earnest Money Request, as illustrated in FIG. 59, the buyer's agent may be notified that a previous Earnest Money Request has been made for the property. The agent can then be required to select one of three actions to continue such as (1) cancel the previous request and submit the new one; (2) keep the previous one and submit the new one; or (3) keep the previous one and do not submit the new one.

In some embodiments, the agent has access to view all of the transactions in the disclosed system for the agent's buyers and listings, as illustrated in FIG. 60. The details displayed on the transactions page can include, for each property, the MLS number, street address, city, state, zip, buyer's name, and various transaction data such as, but not limited to, the Trust Account Nickname, date and time of the latest activity, amount of the earnest money payment, invoice number, and payment status.

The various payment status categories for agents, including ‘Email Sent’, ‘Payment Form Opened’, ‘Submitted’, ‘Settled’, ‘Returned’, ‘Canceled’, ‘Refund Submitted’, ‘Refund Settled’, ‘Error’, ‘Declined’ and ‘Expired’ are the same as described above.

Designated trust account holders also may need to receive payments for services or for real estate transactions where the property is not listed in the MLS. Since the disclosed secure transaction system is dependent, in part, on data listed in the MLS, the system also offers three online payment solutions to Members so they can receive payments for properties that are not connected to the MLS data.

The first online payment solution is an online bill pay product that is a customizable and secure online form branded for a Member's website and that allows any consumer who links to the form to make an ACH payment to the Member without requiring login access. Upon submitting the payment, the Member and the consumer both receive an email receipt of the completed transaction. The Member may have access to the virtual terminal to view and manage these transactions.

The second online payment solution is a member portal that is a secure website customized and branded for Members. The portal allows Members to send data into this service via secure FTP (file transfer protocol) that provides buyers access to the portal. It also provides Members with the ability to view and download information, such as payment requirements, to share securely with the buyer. The buyer may have the ability to provide response information and to make payments accordingly. Upon submitting the payment, the Member and the buyer can both receive email receipts. The Member can have access through the virtual terminal to view and manage these transactions. Members may have access to consumer responses and data provided within the Portal.

The third online payment solution is an application program interface (“API”) service that is utilized by Members who have their own secure web-based system and desire to process secure ACH payments and have transaction status results returned to their own system. The Member can have access to the virtual terminal to view and manage these transactions.

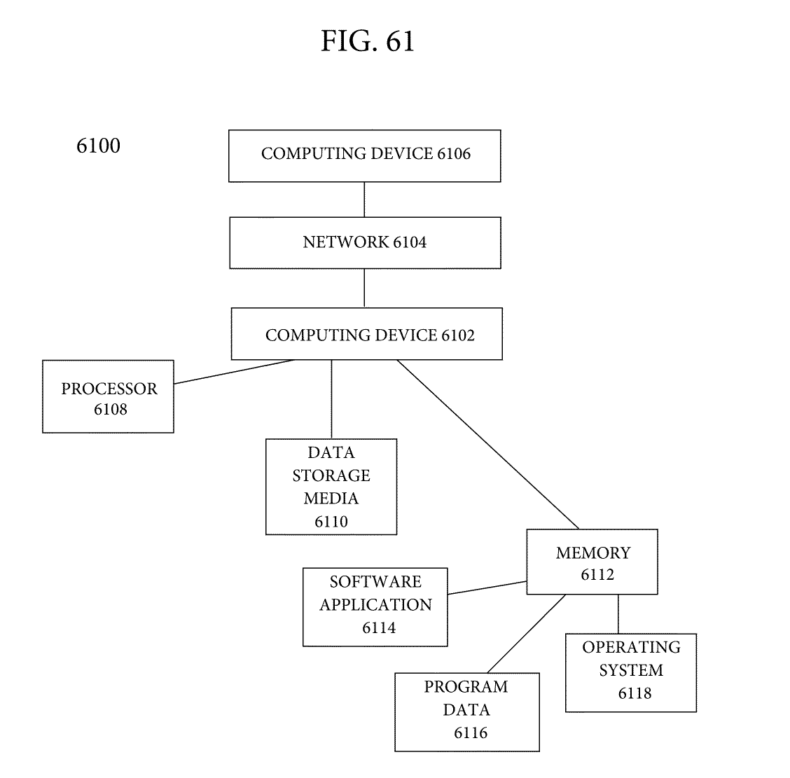

In some embodiments, the system described herein uses a computing system to carry out the various functions described herein. FIG. 61 is a schematic block diagram of an example computing system 6100. The example computing system 6100 includes at least one computing device 6102. In some embodiments the computing system 6100 further includes a communication network 6104 and one or more additional computing devices 6106 (such as a server).

The computing device 6102 can be a computing device 6102 located in a user's home or other place of business. In some embodiments, computing device 6102 is a mobile device. The computing device 6102 can be a stand-alone computing device or a networked computing device that communicates with one or more other computing devices 6106 across a network 6104. The additional computing device(s) 6106 can be, for example, located remotely from the first computing device 6102, but configured for data communication with the first computing device 6102 across a network 6104.

In some examples, the computing devices 6102 and 6106 include at least one processor or processing unit 6108 and system memory 6112. The processor 6108 is a device configured to process a set of instructions. In some embodiments, system memory 6112 may be a component of processor 6108; in other embodiments system memory 6112 is separate from the processor 6108. Depending on the exact configuration and type of computing device, the system memory 6112 may be volatile (such as RAM), non-volatile (such as ROM, flash memory, etc.) or some combination of the two. System memory 6112 typically includes an operating system 6118 suitable for controlling the operation of the computing device 6102, such as the WINDOWS® operating systems or the OS X operating system, or a server, such as Windows SharePoint Server, also from Microsoft Corporation, or such as a Mac running OS X. The system memory 6112 may also include one or more software applications 6114 and may include program data 6116.

The computing device 6102 may have additional features or functionality. For example, the computing device 6102 may also include additional data storage devices 6110 (removable and/or non-removable) such as, for example, magnetic disks, optical disks, or tape. Computer storage media 6110 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 6110 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 6102. An example of computer storage media 6110 is non-transitory media.

In some examples, one or more of the computing devices 6102 and 6106 can be located in an establishment. In other examples, the computing device 6102 can be a personal computing device that is networked to allow the user to access and utilize the system disclosed herein from a remote location, such as in a user's home, office or other location. In some embodiments, the computing device 6102 is a smart phone tablet, laptop computer, personal digital assistant, or other mobile device. In some embodiments, system operations and functions are stored as data instructions for a smart phone application. A network 6104 facilitates communication between the computing device 6102 and one or more servers, such as an additional computing device 6106, that hosts the system. The network 6104 may be a wide variety of different types of electronic communication networks. For example, the network 6104 may be a wide-area network, such as the Internet, a local-area network, a metropolitan-area network, or another type of electronic communication network. The network 6104 may include wired and/or wireless data links. A variety of communications protocols may be used in the network 6104 including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 6106 is a Web server. In this example, the first computing device 6102 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 6108 of the one or more computing devices 6102 or 6106, the instructions cause the processor 6108 to perform one or more of the operations or methods disclosed herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A data security system for electronic payments, comprising:
a designated trust account holder that maintains a plurality of trust accounts;
an ACH processor that underwrites the plurality of trust accounts and provides the data security system with a trust account key for each of the plurality of trust accounts;
an algorithm for determining the correct trust account to use for a transaction and associating the trust account with a designated trust account key; and
a system processor configured to provide the designated trust account key and a buyer's bank account information to the ACH processor, wherein the ACH processor can submit the payment to a bank for processing and send real-time status information on the payment processing to the data security system.
